(19) United States
(12) Patent Application Publication
(10) Pub. No.: US 2006/0243297 A1
(43) Pub. Date: Nov. 2, 2006

(54) Coated monofilament oriented HDPE dental tapes

(76) Inventor: Dale G. Brown, Wharton, TX (US)

Correspondence Address: BANNER & WITCOFF, LTD., 28 STATE STREET, 28th FLOOR, BOSTON, MA, 02109-9601, US

(21) Appl. No.: 11/118,911

(22) Filed: Apr. 29, 2005

(51) Int. Cl. A61C 15/00

(52) U.S. Cl. 132/321

(57) ABSTRACT

The present invention comprises a coated, low-denier, monofilament dental tape, indicating extraordinary gentleness and ease of insertion, that is slit and drawn from biaxially oriented, HDPE, blown film into substantially fibrillation-free, low denier dental tape.

### FIELD OF THE INVENTION

The present invention is directed to coated, monofilament tapes derived from blown extrusion, high density, biaxially oriented, polyethylene (HDPE) film suitable for use as dental devices. The present invention is designated by the trademark “Bi-Ax™ HDPE Tape” to conveniently connote its unique properties. These dental devices are distinct from other commercial monofilament dental tapes on the basis of: thickness, width, denier, edge configuration, ease-of-insertion, overall gentleness, resistance to breaking and fraying, as well as the wide range of saliva soluble or insoluble coatings they can accommodate.

### BACKGROUND OF THE INVENTION

Proper use of dental floss (including dental tape) is necessary to clean the considerable area on the interproximal surfaces of teeth which cannot be reached by the bristles of a toothbrush nor by rinsing. It is estimated that over 40% of tooth surfaces cannot be effectively cleaned by brushing and/or rinsing and require a combination of physical, abrasive and surfactant cleansing at a frequency sufficient to control biofilm buildup.

The purpose of dental floss is:
1. to dislodge and remove any decomposing food material that has accumulated at the interproximal surfaces that cannot be removed by brushing, and
2. to dislodge and remove as much as possible the growth of bacterial biofilm (plaque) upon the teeth or the superimposed calculus that has accumulated there since the previous cleaning.

The concept of the use of dental floss for cleansing interproximal spaces appears to have been introduced by Parmly in 1819 (“Practical Guide to the Management of the Teeth”, Collins & Croft, Philadelphia Pa.). Parmly suggested the use of waxed silk to clean teeth of persons subject to gingival inflammation. Numerous types of floss were developed and used for cleaning, until finally in 1948 Bass established the optimum characteristics of dental floss [Dental Items of Interest, 70, 921-34, (1948)].

Surprisingly, multifilament and monofilament floss marketers have ignored Bass for the past 50 years. Bass warned that dental floss treated with sizing, binders and/or wax produces a “cord” effect that reduces flossing efficiency dramatically. Almost all multifilament floss sold today including unwaxed floss contains binders and/or sizing substances. These “sticky” substances are used to keep the floss twists from falling off a spool during dispensing by holding the floss together.

Additionally, most multifilament floss sold at retail today is also “waxed” to assist penetration to interproximal regions. The resulting “cord” effect described by Bass often makes the floss bundle difficult to force between closely spaced teeth.

The optimum characteristics of dental floss as described by Bass in 1948 have been ignored by most interproximal device manufacturers. Specifically, Bass suggests that these waxed and sized flosses produce an undesirable “cord” effect as discussed above as distinguished from the desirable “spread effect” of unwaxed, unsized floss which flattens out and widens, with the filaments spread out. The potential for separate mechanical action of spread out filaments is nullified by this “cord” effect. Also sacrificed are the spaces between the filaments, which according to Bass are necessary to receive, hold and remove the microscopic material dislodged curing flossing. Thus, the mechanical cleaning attributed to spread filaments and essentially all of the evacuation of microscopic materials from the interproximal spaces by entrapment by these spread-out filaments is impaired or sacrificed with waxed and/or sized flosses, as well as with monofilament tapes, because of this “cord” effect.

It is not surprising that shred resistance has been the basic claim of several dental tape marketers. The introduction of Gore's Glide®, with its monofilament construction, was proposed as the ultimate shred resistant floss. Historically, the typical response to shredding was to develop a “tighter” bonded and smaller diameter floss that did not spread out and did not shred. It is not difficult to see how the “ultimate cord”, i.e., monofilament tape construction, evolved from this approach. Clearly, the monofilament floss is easier to use than traditional bonded multifilament flosses, because of this no-shredding feature. However, shred resistance is achieved with a sacrifice in entrapment and removal of material dislodged during flossing.

It is generally accepted that floss is not a “user-friendly” product, i.e., flossing is difficult to do. It causes pain and bleeding and it results in a bad taste in the mouth. Most market researchers agree that anything that can be done to make the flossing experience more positive should be implemented to encourage more frequent flossing and more wide spread floss use. The addition to floss of various coatings including those saliva-soluble, crystal-free coatings of the present invention which contain chemotherapeutic ingredients, mouth conditioning substances such as silicones, cleaners and SOFT ABRASIVES™ that leave a “clean, just brushed feeling” as taught by the present invention are all sources of positive feed back to the flosser that would be considered encouraging and supportive. To achieve these advances requires basic changes in substrate construction and in the physical chemistry of the floss additives as well as noncoating technology that minimizes the “cord” effect characteristic of waxed floss and monofilament tape.

Shred-resistant monofilament interproximal devices are described and claimed in U.S. Pat. Nos. Re 35,439; 3,800,812; 4,974,615; 5,760,117; 5,433,226; 5,479,952; 5,503,842; 5,755,243; 5,845,652; 5,884,639; 5,918,609; 5,962,572; 5,998,431; 6,003,525; 6,083,208; 6,148,830; 6,161,555 and 6,027,592. These monofilament dental tapes generally have serious shortcomings in: ease of insertion, gentleness, delivering coatings during flossing, being handled easily and conveniently during flossing and removing material dislodged during flossing.

Shred-resistant, polytetrafluoroethylene (PTFE) based monofilament interproximal devices are described in: U.S. Pat. Nos. 5,209,251; 5,033,488; 5,518,012; 5,911,228; 5,220,932; 4,776,358; 5,718,251; 5,848,600; 5,787,758 and 5,765,576. Commercial version include: GLIDE® and Comfort Plus®. To date, no commercial versions of these monofilament tapes have been coated effectively, nor can they be used to deliver active ingredients, interproximally and subgingivally during flossing, nor can these monofilament tapes effectively remove materials from interproximal spaces. Handling PTFE tapes during flossing is difficult. Most have to be folded to provide a consumer acceptable edge. Many PTFE tapes are plagued with serious dimension inconsistency problems, as well.

Multifilament, interproximal devices are described and claimed in U.S. Pat. Nos. 5,033,365; 3,943,949; 6,080,481; 5,830,495; 2,667,443; 4,638,823; 4,029,113; 2,772,205; 2667,443; 4,627,975; 4,414,990; 3,699,979; 3,897,795; 3,838,702; 4,776,358; 5,718,251; 5,603,921; 5,558,901; 5,423,337; 5,357,990; 4,986,288; 3,897,795; 3,928,618; 5,433,226; 5,967,153; 5,908,039; 5,830,495 and 4,033,365. Most of these flosses would not be classified as shred resistant.

The Hill, et al., patents, namely U.S. Pat. Nos. 4,911,927; 5,098,711; 5,165,913 and 5,711,935, describe compression loaded multifilament flosses. All multifilament interproximal devices pose major consumer problems in the areas of shredding, breaking, etc., with the texturized multifilament dental flosses, such as the commercial dental floss, REACH® Gentle Gum Care, exhibiting even greater shredding and breaking shortcomings. It is these shortcoming of the multifilament flosses in general that were instrumental in the commercial success of shred-resistant PTFE and other monofilament devices.

The production of ultra-high molecular weight, compacted, polyethylene film that has been slit into various tapes of varying width and thickness, which is then fibrillated, i.e., penetrated with various cutting means, produce micromesh tapes suitable for compression loading to produce interproximal devices, is described and claimed in U.S. Patent Publication No. 2003/0178044 Al and marketed at retail under the trademark, easySLIDE Pro™. See also: U.S. Pat. Nos. 4,879,076; 4,998,011; 5,002,714; 5,091,133; 5,106,555; 5,106,558; 5,200,129; 5,598,373; 5,693,708 and 5,723,388. Specific methods of fibrillating films are described in U.S. Pat. Nos. 2,185,789; 3,214,899; 2,954,587; 3,662,930 and 3,693,851 and Japanese Patent Publication Nos. 13116/1961 and 16909/1968.

All of the foregoing references are hereby incorporated by reference.

Effective oral hygiene requires that three control elements be maintained by the individual:

Physical control, disruption and removal of stains, plaque (biofilm) and tartar. This is accomplished in the strongest sense by scraping and abrasion in the dentist's office. Self-administered procedures are required frequently between visits and range from toothbrushing with an appropriate abrasive toothpaste, through flossing and rinsing, down to certain abrasive foods and even the action of the tongue against the tooth surface.

Surfactant cleansing, where the source of the surfactant is generally: toothpaste, mouth rinse and/or dental floss. This is required to remove: food debris and staining substances before they adhere to the tooth surfaces; normal dead cellular (epithelial) material which is continually sloughed off from the surfaces of the oral cavity and microbial degradation products derived from all of the above. Besides the obvious hygienic and health benefits related to simple cleanliness provided by surfactants, there is an important cosmetic and sense-of-well-being benefit provided by surfactant cleansing. Research has shown that a primary source of bad breath is the retention and subsequent degradation of dead cellular material sloughed off continuously by the normal, healthy mouth or dislodged from interproximal surfaces by flossing and not subsequently entrapped and removed by the interproximal device.

Frequency of cleaning. This is perhaps the most difficult to provide in today's fast-paced work and social environment. Most people recognize that their teeth should be brushed at least three times a day and flossed at least once a day. The simple fact is that most of the population brush once a day; some brush morning and evening, but precious few carry toothbrush and dentifrice to use the other three or four times a day for optimal oral hygiene. Consumer research suggests that the population brushes an average of 1.3 times a day. Most surprising, less than 10% of adults floss regularly. Reasons offered for not flossing: difficult to do, painful, does not appear to be working, inconvenient and leaves a bad taste. Overall, floss is not perceived as a “consumer friendly” product.

### History and Physical Chemistry of HDPE

Working with ethylene at high pressure, British chemists, Eric Fawcett and Reginald Gibson, created a solid form of polyethylene in 1935. Its first commercial application came during World War II, when the British used it to insulate radar cables. In 1953, Karl Ziegler of the Kaiser Wilhelm Institute (renamed the Max Planck Institute) and Erhard Holzkamp invented high-density polyethylene (HDPE). The process included the use of catalysts and low pressure, which is the basis for the formulation of many varieties of polyethylene compounds. Two years later, in 1955, HDPE was produced as pipe. For his successful invention of HDPE, Ziegler was awarded the 1963 Nobel Prize for Chemistry.

High-density polyethylene (HDPE) (with a density of from 0.941 g/cc to 0.965 g/cc) is a thermoplastic material composed of carbon and hydrogen atoms joined together forming high molecular weight products as shown in FIG. 6—Schematic 1-1c. Methane gas (Schematic 1-1a) is converted into ethylene (Schematic 1-1b), then, with the application of heat and pressure, into polyethylene (Schematic 1-1c). The polymer chain may be 500,000 to 1,000,000 carbon units long. Short and/or long side chain molecules exist with the polymer's long main chain molecules. The longer the main chain, the greater the number of atoms, and consequently, the greater the molecular weight. The molecular weight, the molecular weight distribution and the amount of branching determines many of the mechanical and chemical properties of the end product.

Other common polyethylene (PE) materials are medium-density polyethylene (MDPE) (with a density of from 0.926 g/cc to 0.940 g/cc) used for low-pressure gas pipelines; low-density polyethylene (LDPE) (with a density of from 0.910 g/cc to 0.925 g/cc), typical for small diameter water-distribution pipes; Linear low-density polyethylene (LLDPE), which retains much of the strength of HDPE and the flexibility of LDPE, has application for drainage pipes. Less common PE materials are ultra-high molecular weight polyethylene (UHMWPE) (density above 0.965 g/cc) and very low density polyethylene (VLDPE) (density below 0.910 g/cc).

The property characteristics of polyethylene depend upon the arrangement of the molecular chains. The molecular chains, shown schematically in Schematic 1 -1c, are three-dimensional and lie in wavy planes. Not shown, but branching off the main chains, are side chains of varying lengths. The number, size and type of these side chains helps determine, in large part, the properties of density, stiffness, tensile strength, flexibility, hardness, brittleness, elongation, creep characteristics, melt viscosity, resistance to shredding, resistance to folding and ease-of-insertion.

Polyethylene is characterized as a semi-crystalline polymer, made up of crystalline regions and amorphous regions. Crystalline regions are those of highly ordered, neatly folded, layered (in parallel) and densely packed molecular chains. These occur only when chains branching off the sides of the primary chains are small in number. Within crystalline regions, molecules have properties that are locally (within each crystal) directionally dependent. Where tangled molecular chains branching off the molecular trunk chains interfere with or inhibit the close and layered packing of the trunks, the random resulting arrangement is of lesser density, and termed amorphous. An abundance of closely packed polymer chains results in a tough material of moderate stiffness.

High-density polyethylene resin has a greater proportion of crystalline regions than low-density polyethylene. The size and size distribution of crystalline regions are determinants of the tensile strength and environmental stress crack resistance of the end product. HDPE, with fewer branches than MDPE or LDPE, has a greater proportion of crystals, which results in greater density and greater strength (see FIG. 6, Schematic 1-2). LDPE has a structure with both long and short molecular branches. With a lesser proportion of crystals than HDPE, it has greater flexibility but less strength. LLDPE structurally differs from LDPE in that the molecular trunk has shorter branches, which serve to inhibit the polymer chains becoming too closely packed. Hypothetically, a completely crystalline polyethylene would be too brittle to be functional and a completely amorphous polyethylene would be wax-like, much like paraffin. Upon heating, the ordered crystalline structure regresses to the disordered amorphous state; with cooling, the partially crystalline structure is recovered. This attribute permits thermal welding of polyethylene to polyethylene.

The melting point of polyethylene is defined as that temperature at which the plastic transitions to a completely amorphous state. In HDPE and other thermoplastic materials, the molecular chains are not cross-linked and such plastics will melt with the application of a sufficient amount of heat. With the application of heat, thermoplastic resins may be shaped, formed, molded and extruded.

See also FIGS. 1 through 4 of the Drawings.

During processing, elevated temperatures and energy associated with forming and shaping the polyethylene cause random orientations of molecules within the molten material to directionally align in the extruding orifice. See FIG. 1. At room temperatures, the ordered arrangement of the layered crystalline polyethylene molecules is maintained. Tie molecules link the crystalline and amorphous regions. When the capacities of the polymer chains are overwhelmed by tension, the polymer flows (alters its shape). Tensile forces (stresses) then initiate brittle fracture, evidenced by cracking. In HDPE this may occur at very high strain rates.

The density of polyethylene is a measure of the proportions of crystals within its mass. Crystals, a result of the layering and close packing of polyethylene molecules, are denser than the tangled, disordered arrangement of molecules in the amorphous regions. Copolymers are often used to create and control the formation of side branches. Homopolymers, with densities of 0.960 and above, are produced without copolymers and experience very little branching. To reduce the density, butane, hexane or octane are added to make a copolymer. Butene will add branches two carbon units long; hexane, four carbon units long; and octane, six carbon units long. The greater the length of the branched carbon chains, the lower the final density. ASTM D 3350 classifies polyethylene by density as follows: high-density polyethylene (HDPE) (0.941≦density<0.925), medium-density polyethylene (MDPE) (0.926≦density<0.940). Less commonly employed PE materials are homopolymers (density>0.965) and very low density polyethylene (VLDPE) (density<0.910). Flexural stiffness and tensile strength increase with density; the result is increasing brittleness, and decreasing toughness and stress crack resistance.

The point at which a stress causes a material to deform beyond its elastic region (permanent deformation) is called the tensile strength at yield. When stressed below the yield point, an elastic material recovers all the energy that went into its deformation.

Recovery is possible for polyethylene when the crystals are subjected to low strain levels and maintain their integrity. A formulation of greater density (higher fraction of crystals, lower melt index) is predictive of greater tensile strength and increasing brittleness. The force required to break the test sample is called the ultimate strength or the tensile strength at break. The strength is calculated by dividing the force (at yield or break) by the original cross-sectional area. ASTM D 638, Standard Test Method for Tensile Properties of Plastics, is used to determine the tensile properties of polyethylene pipe resins. Test specimens are usually shaped as a flat “dog bone”, but specimens can also be rod-shaped or tubular per ASTM D 638. During the tensile test, polyethylene, which is a ductile material, exhibits a cold drawing phenomenon once the yield strength is exceeded. The test sample develops a “neck down” region where the molecules begin to align themselves in the direction of the applied load. This strain-induced orientation causes the material to become stiffer in the axial direction while the transverse direction (90° to the axial direction) strength is lower. The stretching or elongation for materials such as polyethylene can be ten times the original gauge length of the sample (1000% elongation). Failure occurs when the molecules reach their breaking strain or when test sample defects, such as edge nicks, begin to grow and cause failure. Fibrillation, the stretching and tearing of the polymer structure, usually occurs just prior to rupture.

Tensile or compressive elastic deformation of a test specimen along a longitudinal axis excite respective inward or outward deformation parallel to a transverse axis normal to the first. Poisson's ratio is the ratio of lateral strain to longitudinal strain. When tested to ASTM E 132, Standard Test Method for Poisson's Ratio at Room Temperature, Poisson's ratio for polyethylene is between 0.40 and 0.45.

Generally, in the preparation of a film from granular or pelleted polymer resin, the polymer is first extruded to provide a stream of polymer melt, and then the extruded polymer is subjected to the film-making process. Film-making typically involves a number of discrete procedural stages, including melt film formation, quenching, and windup. For a general description of these and other processes associated with film-making, see K. R. Osborn and W. A. Jenkins, Plastic films: Technology and Packaging Applications, Technomic Publishing Co., Inc., Lancaster, Pa. (1992), which is incorporated herein by reference.

### Orientation

A key element of the film-making process used for the HDPE films of the invention is a procedure known as “orientation.” The “orientation” of a polymer is a reference to its molecular organization, i.e., the orientation of molecules relative to each other. Similarly, the process of “orientation” is the process by which directionality (orientation) is imposed upon the polymeric arrangements in the film. The process of orientation is employed to impart desirable properties to films, including making cast films tougher (higher tensile properties). Depending on whether the film is made by casting as a flat film or by blowing as a tubular film, the orientation process requires substantially different procedures. This is related to the different physical characteristics possessed by films made by the two conventional film-making processes: casting and blowing. Generally, blown films tend to have greater stiffness, toughness and barrier properties. By contrast, cast films usually have the advantages of greater film clarity and uniformity of thickness and flatness, generally permitting use of a wider range of polymers and producing a higher quality film.

Orientation is accomplished by heating a polymer to a temperature at or above its glass-transition temperature (T_{g}) but below its crystalline melting point (Tₘ), and then stretching the film quickly. On cooling, the molecular alignment imposed by the stretching competes favorably with crystallization and the drawn polymer molecules condense into a crystalline network with crystalline domains (crystallites) aligned in the direction of the drawing force. See FIG. 2. As a general rule, the degree of orientation is proportional to the amount of stretch, and inversely related to the temperature at which the stretching is performed. For example, if a base material is stretched to twice its original length (2:1) at a higher temperature, the orientation in the resulting film will tend to be less than that in another film stretched 2:1 but at a lower temperature. Moreover, higher orientation also generally correlates with a higher modulus, i.e., measurably higher stiffness and strength.

When a film has been stretched in a single direction (monoaxial orientation), the resulting film exhibits great strength and stiffness along the direction of stretch, but it is weak in the other direction, i.e., across the stretch, often splitting or tearing into fibers (fibrillating) when flexed or pulled. To overcome this limitation, two-way or biaxial orientation is employed to more evenly distribute the forces on the film in two directions, in which the crystallites are sheetlike rather than fibrillar. These biaxially oriented films tend to be stiffer and stronger, and also exhibit much better resistance to flexing or folding forces, leading to their greater utility in packaging applications.

From a practical perspective, it is possible, but technically and mechanically quite difficult, to biaxially orient films by simultaneously stretching the film in two directions. Apparatus for this purpose is known, but tends to be expensive to employ. As a result, most biaxial orientation processes use apparatus which stretches the film sequentially, first in one direction and then in the other. Again, for practical reasons, typical orienting apparatus stretches the film first in the direction of the film travel, i.e., in the longitudinal or “machine direction” (MD), and then in the direction perpendicular to the machine direction, i.e., axial or lateral or “transverse direction” (TD). See FIGS. 1 through 4. The degree to which a film can be oriented is also dependent upon the polymer from which it is made. Polypropylene, as well as polyethylene terephthalate (PET), and nylon, are polymers which are highly crystalline and are readily heat stabilized to form dimensionally stable films. These films are well known to be capable of being stretched to many times the dimensions in which they are originally cast (e.g., 5× by 8× or more for polypropylene).

High density polyethylene (HDPE) exhibits even higher crystallinity (e.g., about 80-95%) relative to polypropylene (e.g., about 70%), and HDPE-containing films are generally more difficult to orient biaxially than polypropylene films. U.S. Pat. Nos. 4,870,122 and 4,916,025 describe imbalanced biaxially oriented, HDPE-containing films which are oriented up to about two times in the machine direction, and six times or more in the transverse direction. This method produces a film that tears relatively easily in the transverse direction. Multi-layer films prepared according to this method are also disclosed in U.S. Pat. Nos. 5,302,442; 5,500,283 and 5,527,608, the disclosures of which are incorporated herein by reference in their entireties.

British Pat. No. 1,287,527 describes high density polyethylene films which are biaxially oriented in a balanced fashion to a degree of greater than 6.5 times in both the longitudinal dimension (i.e., MD) and the lateral dimension (i.e., TD). This method requires a specific range of orientation temperatures.

U.S. Pat. Nos. 4,891,173 and 5,006,378 each disclose methods for preparing HDPE films which requires cross-linking the film, with optional biaxial orientation of the cross-linked film. It is reported that the cross-linking process, which requires irradiation of the film, improves the film's physical properties. Other cross-linking processes, such as chemically-induced cross-linking, can have similar effects.

U.S. Pat. No. 4,680,207 relates to imbalanced biaxially oriented films of linear low density polyethylene (LLDPE) oriented by being stretched up to 6-fold in the machine direction, and up to 3-fold in the transverse direction, but less than in the machine direction.

U.S. Pat. No. 5,241,030 describes biaxially oriented films of a blend of at least 75% of a linear ethylene/alpha-olefin copolymer, but no more than 25% HDPE. The film can be mono- or multi-layered, and can be biaxially oriented, i.e., stretched up to 8:1 in the machine direction, and up to 9:1 in the transverse direction.

One of the most common methods of film manufacture is Blown Film (also referred to as the Tubular Film) Extrusion. The process involves extrusion of a plastic through a circular die, followed by “bubble-like” expansion. The principal advantages of manufacturing film by this process are the ability to:
Produce tubing (both flat and gussetted) in a single operation
Regulation of film width and thickness by control of the volume of air in the bubble, the output of the extruder and the speed of the haul-off
Eliminate end effects such as edge bead trim and non uniform temperature that can result from flat die film extrusion
Capability of biaxial orientation
Control fibrillation and enhance softness and flexibility with the use of antifibrillation agents including: ethylene methyl methacrylate (EMAC) and ethylene butyl acrylate (EBAC).

In principal this process is similar to a simple film or sheet extrusion process. The difference is that orientation will be achieved both in machine direction, and in traverse direction by using tenter clamps.

In addition to improved tensile strength at stretch ratios of 3:1 to 4:1, better transparency (as in biaxially oriented, crystalline polypropylene BOPP) will be achieved by this method. Tenter clamps will be used to stretch the film in the traverse direction, which is perpendicular to the machine direction. In case of polyethylene, biaxial orientation can be achieved by blow film extrusion method.

The process of extrusion blow molding is designed to produce plastic films and sheets. It has the characteristics of a biaxial stretching process where the melt is stretched in both radial and longitudinal directions.

The biaxial deformation is applied in a process as follows:
1. The polymer melt enters the die,
2. flows around a mandrel,
3. then it emerges through a ring-shaped opening in the form of a tube,
4. the tube is expanded into a bubble of the required diameter by internal air pressure. Air is trapped in the bubble because it is sealed by the die at one end and by the nip or pinch rolls at the other;
5. the melt is finally cooled below its softening point by a blowing ring around the die which blows cooling air on it.
6. This will cause a frost line to appear in the film, which is the place where transformation from clear, amorphous melt to cloudy, crystalline structure occurs.

### OBJECTS OF THE INVENTION

An object of the invention is to develop a gentler, coated, low-denier, monofilament dental tape with improved insertion attributes.

Another object of the invention is to develop a coated, low-denier, HDPE, monofilament dental tape with acceptable break strength that, during flossing, indicates improved gentleness and ease of insertion.

A further object of the invention is to develop a coated, HDPE dental tape that can be worked between tight spaces while resisting bending, breaking, fraying and/or fibrillating.

Yet another object of the invention is to develop a method for manufacturing coated, thin HDPE, monofilament dental tape from blown extrusion HDPE film with improved gentleness, flexibility and ease of insertion.

Still another object of the invention is to control, disrupt and remove biofilms from tight interproximal surfaces, while treating: gingivitis, periodontitis and/or bad breath.

Another object of the invention is to deliver cleaning, toothpaste, nutraceutical, and/or antimicrobial ingredients and combinations thereof to interproximal sites by flossing with a blown extrusion-based HDPE substrate, coated with such ingredients.

A further object of the invention is to improve flossing compliance with a low-denier, gentler, easier- to-insert, monofilament dental tape that resists fraying, breaking, bending and fibrillating, while being worked between tight interproximal spaces.

Yet another object of the invention is to improve flossing by contacting more interproximal surfaces with each stroke of a low-denier, dental tape that has improved width, flexibility, tensile strength and resistance to fraying, bending and fibrillating.

These and other objects of the invention will become apparent from the disclosure below.

### SUMMARY OF THE INVENTION

The present invention is directed to improved, low-denier, biaxially oriented, coated HDPE monofilament dental tapes that exhibit exceptional ease-of-insertion and gentleness when worked between interproximal spaces.

This exceptional ease-of-insertion and gentleness of HDPE dental tapes of the invention is attributed to:
(1) The monofilament construction, per se, as distinguished from multifilament construction;
(2) The thickness of the tape. Traditionally, monofilament dental tapes have been between 2 and about 4 mils thick. See Chart 2 below. Heretofore, dental tapes in the 1 to about 2 mil thickness range have been considered too weak to be effective and tend to be prone to folding, i.e., doubling-up on insertion into tight spaces;
(3) The break strength of the tape. See Table 1 below. Higher break strengths at minimum thickness and maximum width assures that the thin tapes of the invention can be worked gently through tight interproximal spaces without breaking, a major shortcoming of some commercial tapes. Drawing HDPE blown, biaxially oriented films and HDPE modified films containing EMAC and/or EBAC copolymer antifibrillation agents, as taught in the present invention, results in longitudinal orientation with increased break strength, while retaining sufficient transverse orientation to impart transverse strength and resistance to fibrillation during flossing;
(4) The coating on the film. See Table 1 below. Traditional “wax” coatings, particularly those that are not readily saliva soluble, tend to be physically “stripped” from the device during flossing and collect at the entry to the interproximal sites. In contrast, the preferred wax, compression coatings and saliva soluble coatings applied to the HDPE tapes of the present invention by contact coating are released into interproximal spaces upon contact with saliva. These released coatings can contain various antiplaque ingredients, such as MICRODENT® and/or ULTRAMULSIONS®, that tend to “lubricate” the HDPE monofilament as it is worked over interproximal sites between teeth. This resultant “in-situ” lubrication dramatically reduces the “drag” on the HDPE monofilament tape as it is being worked between teeth, and thereby contributes dramatically to the perception of gentleness for the various coated HDPE dental tapes of the invention;
(5) The “hand” of the coated HDPE monofilament dental tape. See Table 1 below. The substantive coatings applied to both sides of the tapes of the present invention are responsible for the exceptional “hand” and ease of use as indicated by the “hand” feature of the tapes of the present invention, which allows said tapes to be wrapped around fingers and held taut while working the tape between teeth with no finger discomfort such as experienced when using the commercial PTFE tapes with their minimal wax coatings; and
(6) The dimensional consistency of the slit and drawn, HDPE, blown film sourced tapes of the present invention. See Table 2 below.

Slitting, i.e., the continuous cutting of HDPE extrusion blown films into narrow films of consistent width, followed by “drawing” of these narrow films into biaxially oriented, thinner tapes, results in the dental tapes of the present invention, having:
(a) dimensional consistency,
(b) substantially reduced thickness,
(c) substantially increased width,
(d) surprisingly increased break strength,
(e) distinctive ease-of-insertion and gentleness properties, and
(f) unexpected rounded edges. See Tables 1, 2, 6, and 7 and the photograph included with FIG. 5 of the Drawings.

The dimensions of the HDPE tapes of the present invention, along with their edge finish, are compared to the dimensions and edge finish of several commercial monofilament dental tapes. These comparisons are reported in Table 2 below. The reading of tape width and thickness were made on five different 18-inch segments removed from a commercial bobbin at 10 yd intervals. Each 18-inch piece had the coating removed by extraction/solution prior to taking measurements. Denier and coating levels were also reported. The edge finish of the HDPE tapes of the invention is indicated in the photograph designated FIG. 5 of the Drawings.

Accordingly, one embodiment of the present invention is directed to a coated, low-denier, monofilament, shred-resistant dental tape, which is slit and drawn from extrusion blown HDPE film indicating transverse and longitudinal orientation, high break strength and a rounded edge.

Preferably, the dental is coated with a coating selected from the group consisting of wax; compression-saliva soluble-substantially-crystal-free coatings; and contact-saliva soluble-substantially-crystal-free coatings; wherein said coating is applied at from between about 10 and about 80 mg/yd.

Preferably, the dental tape is from between about 0.6 and about 2 mils thick and from between about 20 and about 80 mils wide.

Preferably, the HDPE film of the dental tape has a density of at least about 0.940 g/cc.

Preferably, the dental tape has a denier between about 350 and about 550.

Preferably, the HDPE film of the dental tape is drawn at between about 3:1 and 16:1.

Preferably, the dental tape has a break strength of at least about four pounds.

Preferably, the HDPE film of the dental tape contains a minor amount of an anti-fibrillation resin.

Another embodiment of the present invention is directed to a method for controlling, disrupting and removing biofilms from interproximal tooth surfaces comprising routinely flossing with a coated, low-denier, monofilament, shred-resistant dental tape, slit and drawn from extrusion blown HDPE film, indicating transverse and longitudinal orientation, high break strength and a rounded edge.

Preferably, in the method embodiment, the tape is coated with a coating selected from the group consisting of wax; compression—saliva-soluble-substantially crystal-free coatings; and contact—saliva-soluble-substantially crystal-free coatings; wherein said coating is applied at from between about 10 and about 80 mg/yd.

Preferably, in the method embodiment, the tape is from between about 0.6 and about 2 mils thick and from between about 20 and about 80 mils wide.

Preferably, in the method embodiment, the HDPE film has a density of at least about 0.940 g/cc.

Preferably, in the method embodiment, the tape has a denier from-between about 350 and about 550.

Preferably, in the method embodiment, the tape film is drawn at between about 3:1 and 16:1.

Preferably, in the method embodiment, the tape has a break strength of at least about four pounds.

Preferably, in the method embodiment, the HDPE film contains a minor amount of an anti-fibrillation resin.

Yet another embodiment of the present invention is directed to a method for manufacturing coated, low-denier, monofilament, shred-resistant dental tape, slit and drawn from extrusion blow molded HDPE film, indicating transverse and longitudinal orientation, high break strength and a rounded edge, comprising the steps of:
(a) slitting and drawing said film into a shred resistant tape that is substantially fibrillation free with rounded edges, and
(b) coating said tape with a coating selected from the group consisting of wax; compression—saliva-soluble-substantially crystal-free coatings; and contact—saliva-soluble-substantially crystal-free coatings; wherein said coating is applied at from between about 10 and about 80 mg/yd.

Preferably, in the manufacturing embodiment, the tape is from between about 0.6 and about 2 mils thick and from between about 20 and about 80 mils wide.

Preferably, in the manufacturing embodiment, the HDPE film has a density of at least about 0.940 g/cc.

Preferably, in the manufacturing embodiment, the tape has a denier from between about 350 and about 550.

Preferably, in the manufacturing embodiment, the film is drawn at between about 3:1 and 16:1.

Preferably, in the manufacturing embodiment, the tape has a break strength of at least about four pounds.

Preferably, in the manufacturing embodiment, the HDPE film contains a minor amount of an anti-fibrillation resin.

### BRIEF DESCRIPTION OF DRAWINGS

FIGS. 1 through 4 schematically illustrate molecular orientation of HDPE at various stages of extruding and blow extruding respectively before and after heat drawings.

FIG. 5 is a microphotograph of an edge of bi-axially oriented HDPE dental tape drawn from blown film, looking down at a tape standing on edge with a light shining on the edge. This illustrates the surprisingly rounded “gentle” edge of slit/drawn, oriented HDPE dental tape of the invention.

FIG. 6 shows Schematics I-1a,b,c and 1-2—which illustrate components of HDPE and the linear and branched structures thereof.

FIG. 7 illustrates Chart 1—a comparison of width (in mils) for the dental tapes of the present invention (Bi-Ax™) against commercial products.

FIG. 8 illustrates Chart 2—a comparison of thickness (in mils) for the dental tapes of the present invention (Bi-Ax™) against commercial products.

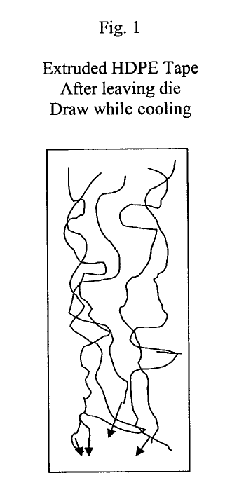

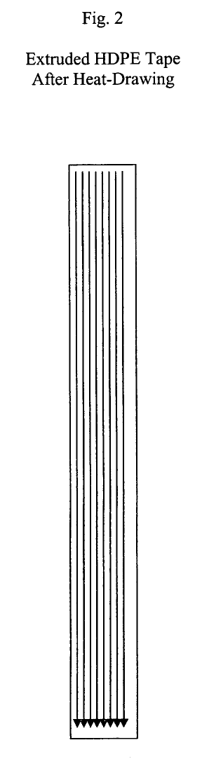

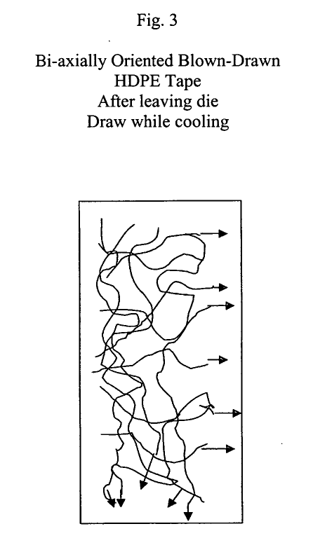

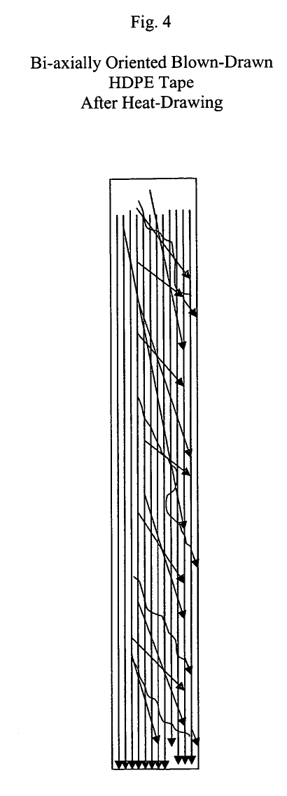

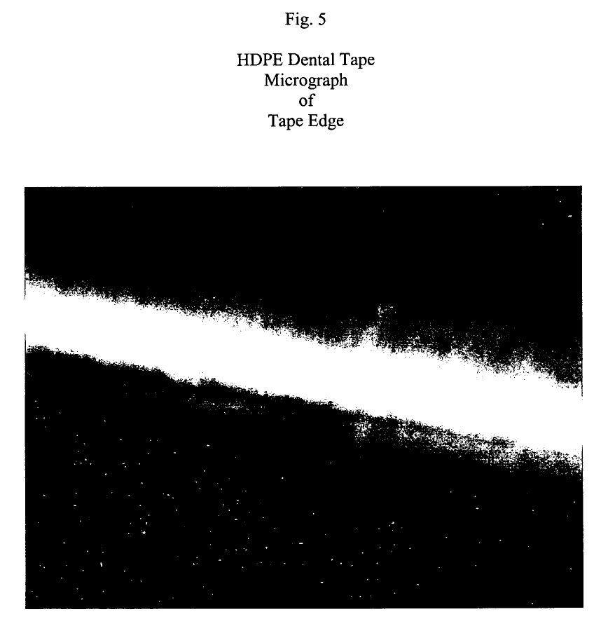

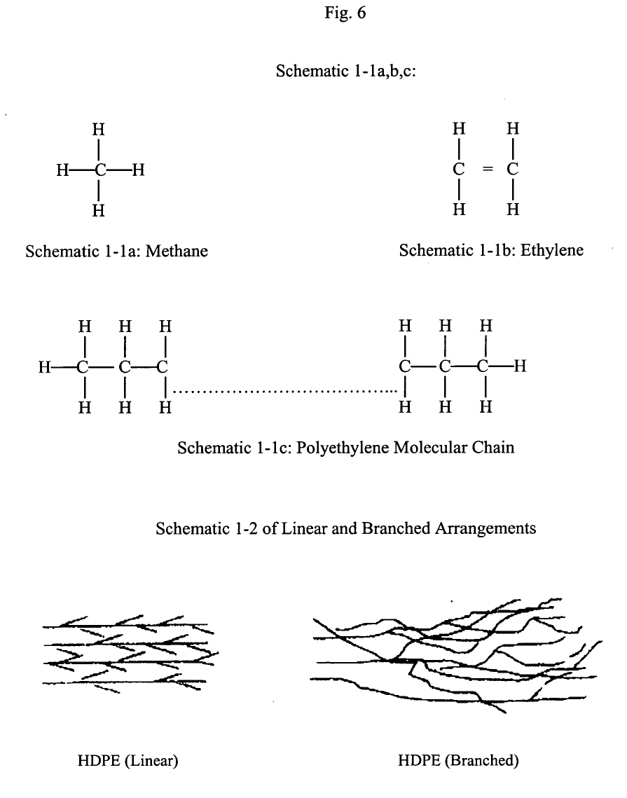

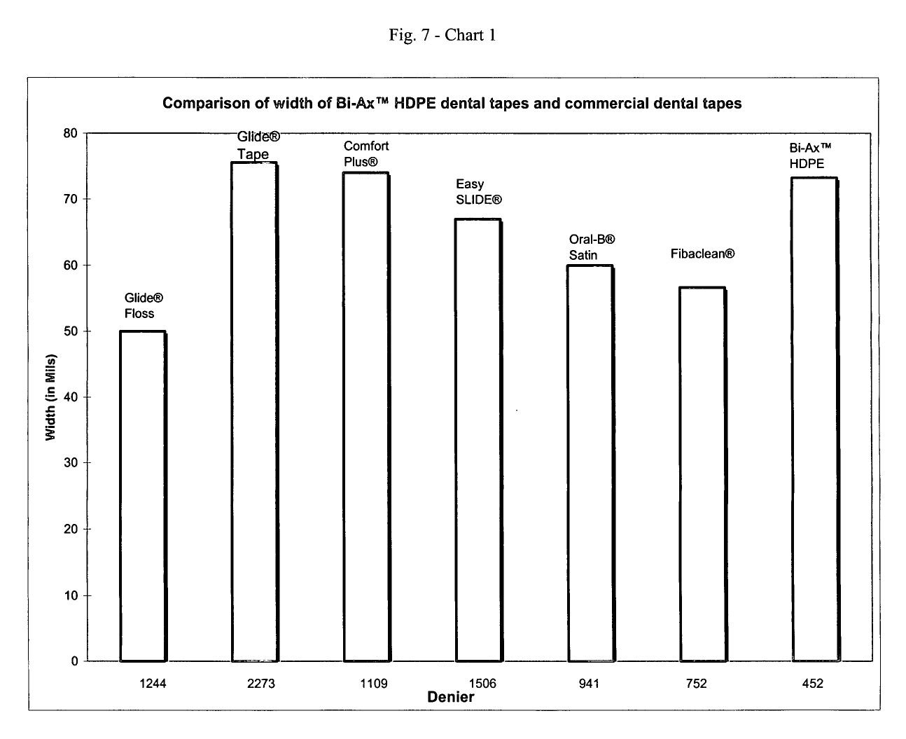

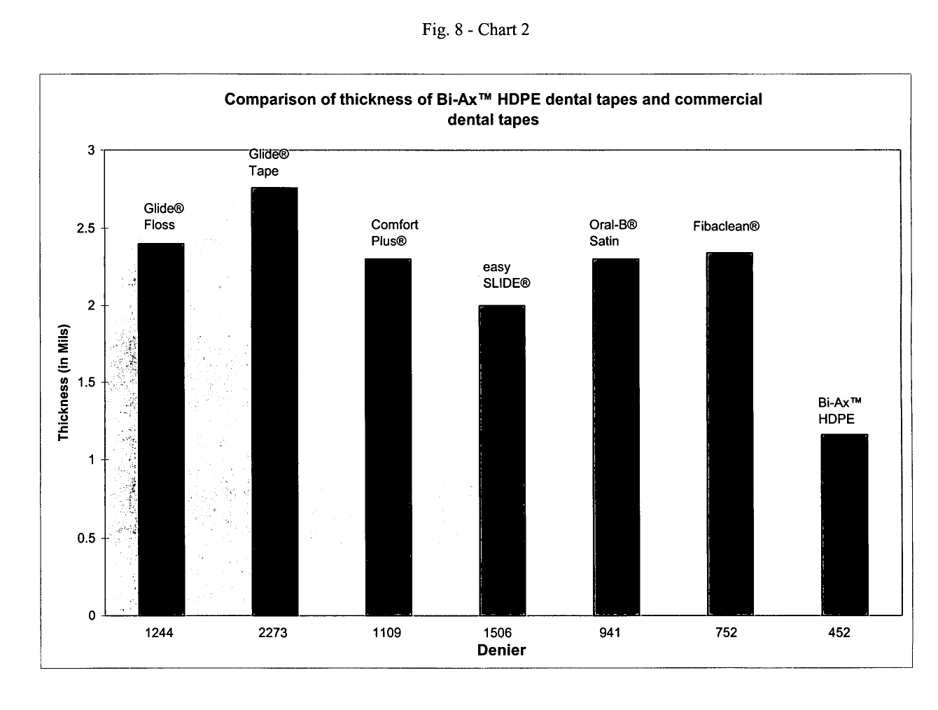

### DEFINITIONS OF KEY TERMS

For the purposes of the present invention, the following key terms are defined as set out below:

As used herein, the term “high density polyethylene (HDPE) is defined to mean an ethylene-containing polymer. See History and Physical Chemistry of HDPE as detailed below. The dental tapes of the present invention use a biaxially oriented, blown film of HDPE, having a density of 0.940 g/cc or higher. Generally, while HDPE having a density of 0.940 and above is acceptable for use, HDPE of higher density is preferred, with HDPE having a density of 0.950 or greater being more preferred. [As the density of HDPE increases from 0.940 to 0.0960 and higher, tensile strength increases substantially. Toughness and impact strength are much higher in the higher molecular grades. See K. R. Osborn and W. A. Jenkins, Plastic Films: Technology and Packaging Applications, Technomic Publishing Co., Inc., Lancaster, Pa. (1992).] While density is a parameter which usefully characterizes HDPEs, it is also recognized that the HDPE suitable for use in the invention generally has a crystalline melting point of about 265° F. (130° C.) and above, and a crystallinity from between about 60 and about 95%.

The melt index (MI) of the HDPE useful according to the invention is in the range of from between about 0.5 and about 10. More preferably, the HDPE has a melt index in the range of from between about 0.5 and about 5.0. Melt index is generally understood to be inversely related to viscosity, and decreases as molecular weight increases. Accordingly, higher molecular weight HDPE generally has a lower melt index. Methods for determining melt index are known in the art, e.g., ASTM D 1238.

The high density ethylene-containing polymers suitable for use in the invention include not only homopolymers of ethylene, but also include copolymers of ethylene with higher alpha-olefins and other monomers such as methacrylates. Suitable high density polyethylene copolymers meeting the requisite criteria are available commercially.

HDPE useful according to the invention can include a copolymer of ethylene with a minor amount of another alpha-olefin or another monomer. Preferred alpha-olefins include C₃-C₈ alpha-olefins. Preferred other monomers include acrylates, methacrylates, etc. Copolymers of ethylene (e.g., about 50% or more) with a minor amount of 1-propylene 1-butylene or methacrylates are more preferred. By selecting the appropriate comonomer, HDPE films can be manufactured having particular desired physical characteristics. For example, the crystallinity and density of the resulting copolymer can be controllably affected by the co-monomer employed with ethylene.

The HDPE can be composed exclusively of a single HDPE resin, a mixture (blend or alloy) of HDPE resins, or HDPE containing a minor proportion of other resource polymers such as methacrylates (polyblend). For example, the HDPE can contain up to about 10 percent by weight (wt. %) methacrylate or microcrystalline wax. These HDPEs typically have melt indices in the range of from between about 0.5 and about 10, and they are usually selected to result in a blend having the desired melt, e.g., from between about 0.7 and about 2. A mixture of HDPE resins generally results in improved break strength and is better processing characteristics in the extruder by reducing extruder torque.

The HDPE blends can include two or more HDPEs or other polymers such as methacrylates, each of which preferably has a density of 0.940 or greater. Blends of HDPE polymers advantageously include a major proportion (i.e., 50 wt. % or more) of a HDPE having a melt index from between about 0.5 and 5.0, and one or more polymers having different melt indices. For example, HDPE terblends have been found to be suitable for use according to the invention. Suitable terblends can, for example, include 50 to 98 wt. %, preferably 84 to 96 wt. % of HDPE having a density of 0.940 or higher and a melt index of greater than 0.5 to about 2.0; 1 to 25 wt. %, preferably 3 to 8 wt. % of ethylene methacrylate copolymer; preferably 3 to 8 wt. %, of HDPE having a density of 0.940 or higher and a melt index of greater than 2 to about 8. Preferably, the second and third polymers, which are minor components, are present in about equal amounts. Other HDPE blends and terblends can also be used.

Blends (alloys, polyblends) of HDPE with a minor amount of one or more other polymers are most useful for dental device substrates. For example, physical properties of the resulting film, including break strength, can be improved by including polymers such as the methacrylates. Additionally, high crystallinity polymers such as polypropylene can be included. Alternatively, lower crystallinity or amorphous polymers, such as polystyrene, styrene-butadiene copolymer, or polyvinyl acetate, can be included. U.S. Pat. No. 4,191,719, for example, which is incorporated herein by reference, describes suitable HDPE materials which are blends including five different components. In this embodiment, the basic HDPE material includes at least about 50 wt. % HDPE, and preferably at least about 90 wt. % HDPE with up to 5% methacrylate.

In another alternative, the HDPE blown film can include a base material which is a blend of HDPE and another polyethylene such as a low density PE (LDPE), ultra-low density PE (ULDPE), or a linear low density PE (LLDPE). The skilled artisan will understand that these other types of polyethylene can be employed in minor amounts to adjust physical properties of the resulting blown films for particular purposes such as break strength. In this embodiment, the base material includes at least about 50 wt. % HDPE, and preferably at least about 90 wt. % HDPE.

As used herein, the term “oriented” refers to an HDPE polymer-containing material which has been elongated (generally at an elevated temperature called the orientation temperature), followed by being “set” in the elongated configuration by cooling the material while substantially retaining the elongated dimensions. This combination of elongation at elevated temperature followed by cooling causes an alignment of the polymer chains to a more parallel configuration, thereby improving mechanical properties, of the film such as break strength, resistance to fraying, etc. Upon subsequent heating unrestrained, unannealed, oriented polymer-containing material to its orientation temperature, heat shrinkage is produced almost to the original dimensions, i.e., pre-elongation dimensions. The term “oriented,” is herein used with reference to oriented films, which can undergo orientation in any one or more of a variety of manners. Orienting is further discussed below. See also discussion of Orientation as detailed below.

Orienting in one direction is referred to herein as “uniaxial orientation,” while orienting in two directions is referred to herein as “biaxial orientation” which is an attribute of the blown extruded HDPE films of the present invention. In oriented plastic films, there can be internal stress remaining in the plastic film which can be relieved by reheating the film to a temperature above that at which it was oriented. Upon reheating such a film, the film tends to shrink back to the original dimensions it had before it was oriented. Biaxial orientation imparts unique and distinctive properties to the interproximal HDPE dental devices of the present invention.

As used herein, the phrase “orientation ratio” refers to the multiplication product of the extent to which the film material is oriented in several directions, usually two directions perpendicular to one another. Orientation in the machine direction is herein referred to as “drawing,” whereas orientation in the axial direction is herein referred to as transverse or “stretching.” For films extruded through an annular die, stretching is obtained by “blowing” the film to produce a bubble. For such films, drawing is obtained by passing the film through two sets of powered nip rolls, with the downstream set having a higher surface speed than the upstream set, with the resulting draw ratio being the surface speed of the downstream set of nip rolls divided by the surface speed of the upstream set of nip rolls divided by the surface speed of the upstream set of nip rolls. The degree of orientation is also referred to as the orientation ratio.

As used herein, the term “monomer” refers to a relatively simple compound, usually containing carbon and of low molecular weight, which can react to form a polymer by combining with itself or with other similar molecules or compounds.

As used herein, the term “comonomer” refers to a monomer which is copolymerized with at least one different monomer in a copolymerization reaction, the result of which is a copolymer.

As used herein, the term “polymer” refers to the product of a polymerization reaction, and is inclusive of homopolymers, copolymers, terpolymers, tetrapolymers, etc. In general, the layers of a film can consist essentially of a single polymer, or can have additional polymers together therewith, i.e., blended therewith.

As used herein, the term “homopolymer” is used with reference to a polymer resulting from the polymerization of a single monomer, i.e., a polymer consisting essentially of a single type of repeating unit.

As used herein, the term “copolymer” refers to polymers formed by the polymerization reaction of at least two different monomers. For example, the term “copolymer” includes the copolymerization reaction product of ethylene and an alpha-olefin, such as 1-hexene. The term “copolymer” is also inclusive of, for example, the copolymerization of a mixture of ethylene, propylene, 1-hexene, and 1-octene.

As used herein, the term “copolymerization” refers to the simultaneous polymerization of two or more monomers. The term “copolymers” is also inclusive of random copolymers, block copolymers, and graft copolymers.

As used herein, a copolymer identified in terms of a plurality of monomers, e.g., “propylene/ethylene copolymer,” refers to a copolymer in which either monomer may copolymerize in a higher weight or molar percent than the other monomer or monomers. However, the first listed monomer preferably polymerizes in a higher weight percent than the second listed monomer, and, for copolymers which are terpolymers, quadripolymers, etc., preferably the first monomer, copolymerizes in a higher weight percent than the second monomer, and the second monomer copolymerizes in a higher weight percent than the third monomer, etc.

As used herein, terminology employing a “/” with respect to the chemical identity of a copolymer (e.g., “an ethylene/alpha-olefin copolymer”), identifies the comonomers which are copolymerized to produce the copolymer. As used herein, “ethylene alpha-olefin copolymer” is the equivalent of “ethylene/alpha-olefin copolymer.”

As used herein, copolymers are identified, i.e., named, in terms of the monomers from which the copolymers are produced. For example, the phrase “propylene/ethylene copolymer” refers to a copolymer produced by the copolymerization of both propylene and ethylene, with or without additional comonomer(s). As used herein, the phrase “mer” refers to a unit of a polymer, as derived from a monomer used in the polymerization reaction. For example, the phrase “alpha-olefin mer” refers to a unit in, for example, an ethylene/alpha-olefin copolymer, the polymerization unit being that “residue” which is derived from the alpha-olefin monomer after it reacts to become a portion of the polymer chain, i.e., that portion of the polymer contributed by an individual alpha-olefin monomer after it reacts to become a portion of the polymer chain.

As used herein, the phrase “heterogeneous polymer” refers to polymerization reaction products of relatively wide variation in molecular weight and relatively wide variation in composition distribution, i.e., polymers made, for example, using conventional Ziegler-Natta catalysts. Such polymers typically contain a relatively wide variety of chain lengths and comonomer percentages.

As used herein, the phrase “homogeneous polymer” refers to polymerization reaction products of relatively narrow molecular weight distribution and relatively narrow composition distribution. Homogeneous polymers are structurally different from heterogeneous polymers, in that homogeneous polymers exhibit a relatively even sequencing of comonomers within a chain, a mirroring of sequence distribution in all chains, and a similarity of length of all chains, i.e., a narrower molecular weight distribution. Furthermore, homogeneous polymers are typically prepared using metallocene, or other single-site type catalysts, rather than using Ziegler-Natta catalysts. A homogenous ethylene/alpha-olefin copolymer including HDPE can, in general, be prepared by the copolymerization of ethylene and any one or more alpha-olefin. Preferably, the alpha-olefin is a C₃-C₂₀ alpha-monoolefin, more preferably, a C₄-C₁₂ alpha-monoolefin, still more preferably, a C₄-C₈ alpha-monoolefin. Still more preferably, the alpha-olefin comprises at least one member selected from the group consisting of butene-1, hexene-1 and octene-1, i.e., 1-butene, 1-hexene and 1-octene, respectively. Most preferably, the alpha-olefin comprises octene-1 and/or a blend of hexene-1 and butene-1.

Processes for preparing and using homogeneous polymers including HDPE are disclosed in U.S. Pat. No. 5,206,075, U.S. Pat. No. 5,241,031, and PCT International Publication No. WO 93/03093, each of which is hereby incorporated by reference thereto, in its entirety. Further details regarding the production and use of homogeneous ethylene/alpha:-olefin copolymers are disclosed in PCT International Publication No. WO 90/03414, and PCT International Publication No. WO 93/03093, both of which are hereby incorporated by reference thereto, in their respective entireties.

Still another species of homogeneous ethylene/alpha-olefin copolymer including HDPE is disclosed in U.S. Pat. No. 5,272,236, and U.S. Pat. No. 5,278,272, both of which are hereby incorporated by reference thereto, in their respective entireties. See also U.S. Pat. Nos. 5,846,620; 6,579,584 and 6,689,857, which are hereby incorporated by reference.

As used herein, the term “shred resistant” describes the propensity of various monofilament interproximal devices to resist shredding, breaking or otherwise becoming discontinuous during flossing. Multifilament devices including texturized multifilament devices tend to be more prone to having individual filaments break and/or shred during flossing than monofilament tapes. On the other hand, certain monofilament tapes including PTFE tapes, and various extruded monofilament tapes, such as Fibaclean™ tape, tend to resist shredding and/or breaking during flossing due to their single monofilament construction combined with the low surface energy property of the tape. That the HDPE monofilament devices of the present invention exhibit ultra shred resistant properties is totally surprising and unexpected considering their ultra-thin tape construction, ease of insertion and gentleness. The thin construction of the HDPE tapes of the invention and the break resistance attributed to their transverse orientation, combined with the “lubricants” in the saliva-soluble, crystal-free coatings of the devices, are believed to be primarily responsible for the exceptional: shred resistance, as well as for the surprising gentleness indicated by the blown HDPE devices of the present invention. It will be evident to one skilled in the art that other “lubricants”, including but not limited to, ordinary waxes such as are commonly used in dental flosses, will improve the shred resistance and gentleness of the present invention.

As used herein, the term “coating” is generally defined as the process of introducing oral care substances onto the HDPE interproximal devices and includes waxing, compression coating and contact coating.

As used herein, the phrase “wax coating” refers to the coating process generally used for most multifilament dental devices and is described in U.S. Pat. Nos. 2,667,443; 5,830,495; 5,908,039 and 5,967,153 and the references cited therein, which are hereby incorporated by reference.

As used herein, the phrase “compression coating” refers to the coating process used for both multifilament and monofilament devices as described in U.S. Pat. Nos. 4,911,927; 5,098,711; 5,165,913; 5,651,959; 5,665,374; 5,711,935; 6,545,077; 6,575,176; 6,591,844; 6,604,534 and 6,609,527, which are hereby incorporated by reference. Commercial dental devices coated by compression coating include: REACH® Gentle Gum Care and easySLIDE Pro™.

As used herein, the phrase “contact coating” describes as the preferred means for coating various “thin” HDPE interproximal devices of the invention, where the coating substance is generally a liquid, low melt viscosity mixture or emulsion which is transferred onto both sides of the HDPE substrate as it is passed over various contact loading means generally described in U.S. Pat. Nos. 2,667,443; 5,830,495; 5,908,039 and 5,967,153.

As used herein, the phrase “contact coatings” generally describes various oral care containing substances suitable for contact coating the HDPE monofilament tapes of the invention. These contact coatings include various low melt viscosity mixtures and emulsions as described below.

As used herein, the phrase “low melt viscosity mixtures and emulsions” generally describes those low viscosity liquid oral care substances including mixtures, emulsions, water soluble coatings suitable for coating onto HDPE interproximal devices of the present invention using various coating means including waxing, contact coating, compression coating and the like.

As used herein, the terms “MICRODENT®” and “ULTRAMULSION®” refer to emulsions of polydimethylsiloxane at various molecular weights in various poloxamer surfactants as described and claimed in U.S. Pat. Nos. 4,911,927; 4,950,479; 5,032,387; 5,098,711; 5,165,913; 5,538,667; 5,645,841; 5,651,959 and 5,665,374. These mouth conditioners are preferably included in the various crystal-free contact coatings of the present invention.

As used herein, the phrase “saliva-soluble, crystal-free coatings” refers to those contact coating emulsions that indicate substantial flake resistance, yet release from the devices of the present invention during flossing when exposed to saliva in the oral cavity. These coatings can include SOFT ABRASIVES™ that are dispersed and not solubilized in said coatings. These SOFT ABRASIVES™ remain insoluble when delivered between teeth and below the gum line during flossing. Additionally, saliva-soluble coatings preferably contain surfactants, mouth conditioners, chemotherapeutic ingredients and flavors that are released from the devices into the oral cavity. See U.S. Pat. Nos. 6,609,527 and 6,575,176.

As used herein, the term “crystal-free” refers to a smooth surface as distinguished from rough surfaces typical of crystalline coatings when observed through a 30× stereo zoom microscope. See U.S. Pat. No. 6,609,527. Generally, crystal-free coatings indicate minimum flaking. Examples of suitable crystal-free coating formulations are detailed in some of the Examples and Tables below.

As used herein, the term “inverse wax emulsion” defines a coating wherein the continuous phase is a suitable wax, such as microcrystalline wax, paraffin wax, beeswax, and the like, and the discontinuous phase is a surfactant. For example, emulsified as the discontinuous phase is a saliva-soluble surfactant solution of flavors, sweeteners, low-level active ingredients and other modifiers which are released into the oral cavity in lesser amounts than the previously described “saliva-soluble, crystal-free coatings”. Upon disrupting by reason of the sawing action of the floss, the continuous wax phase releases greater amounts of said ingredients than a simple wax mixture as commonly used in dental floss manufacture. Formulations similar to the “saliva-soluble” coatings previously described can easily be incorporated into an inverse wax emulsion, as can simpler surfactant solutions as would be evident to one skilled in the art.

As used herein, the term “wax coating” defines a coating comprised primarily of a suitable wax, such as microcrystalline wax, paraffin wax, beeswax, and the like, into which is admixed small amounts of flavors, sweeteners, and low-level active ingredients commonly used in dental floss manufacture. As the wax coating is worked across tooth surfaces during flossing, the wax may be partially removed from the floss substrate and deposited onto tooth surfaces. Generally, very little of the minor ingredients mixed into the wax are released into the oral cavity due to the hydrophobic barrier to saliva solubility indicated by the wax.

As used herein, the term “SOFT ABRASIVES™” defines saliva-soluble and saliva-insoluble abrasive substances suitable for cooperating with the HDPE structure of the devices of the present invention to remove, control and disrupt biofilm, tartar and stained pellicle from tooth surfaces. SOFT ABRASIVES™ include: tetra sodium pyrophosphate, calcium carbonate, dicalcium phosphate, silica, glass beads, polyethylene and polypropylene particles, pumice, titanium oxide, alumina, quartz, aluminum silicate, etc., at various particle sizes suitable for use in oral care. See U.S. Pat. No. 6,575,176.

As used herein, the term “whitening agents” for extrinsic stains refers to those substances which: (a) function as means of oxidation such as carbamide peroxide and hypochlorites, (b) function by interfering with calcium complex deposits such as tetrasodium phosphate or sodium hexametaphosphate (c) function as chelating agents, (d) function as abrasives such as the SOFT ABRASIVES™ described above for stained pellicle disruption, control and removal.

As used herein, the term “cleaners” refers to essentially all surfactants suitable for use in the oral cavity and suitable for coating the HDPE substrates of the interproximal devices of the present invention.

As used herein, the phrase “chemotherapeutic ingredients” refers to those substances suitable for addition to the coatings of the present invention that impart therapeutic effects to the oral cavity including antimicrobials; anti-tartar and anti-plaque substances; remineralizing, desensitizing, NSAID and antibiotic ingredients, and the like. Specific chemotherapeutic ingredients suitable for the present invention include: stannous fluoride, potassium nitrate, cetylpyridinium chloride (CPC), triclosan, metronidazole, chlorhexidine, aspirin and doxycycline.

As used herein, the phrase “substantially flake-free” refers to the propensity of the various device coatings of the present invention to resist flaking off coated HDPE dental flosses during flexure. Flaking resistance is attributed to the crystal-free nature of the coatings and is based on the reduction by weight of the crystal-free coating after flexing, under suitably controlled and reproducible conditions, where an 18-inch piece of coated HDPE tape is flexed for 30 seconds.

As used herein, the term “release value” refers to interproximal device coatings that are released from the substrate during flossing and is defined by measuring the level of coating remaining on 18-inches of the HDPE dental tape after the tape is used to thoroughly floss between all teeth. The percent of the coating removed from the tape during flossing establishes the release value.

As used herein, the term “formula modifiers” refers to those ingredients which are otherwise inactive as cleaners, abrasives or chemotherapeutic agents. Formula modifiers: (a) allow convenient control of the desired melt viscosity of the coating, (b) help provide the desired release rate in the mouth, (c) help provide for desired dispersability properties in the manufacturing process, and (d) improve mouthfeel for consumer acceptance.

As used herein, the term “break strength” defines the force required in pounds to break a fiber or bundle of fibers or a monofilament tape including those of the present invention.

As used herein, the term “multifilament” defines a bundle of monofilament fibers acting as a single cord, suitable for use as an interproximal device. Waxed nylon floss is a classic example of a multifilament dental devices.

As used herein, the term “monofilament” defines a single strand of untwisted tape suitable for use as an interproximal device. Commercial examples of monofilaments include: GLIDE®, COMFORT PLUS® and easySLIDE Pro™.

As used herein, the phrase “dimensional consistency” defines a physical property that, when measured along all three axes, is substantially the same, or when measured over an extended length of the substrate, remains substantially the same.

As used herein, the term “hand” defines the human tactile sensory response to a filament or group of filaments or the tape of the present invention as in “soft hand” or feel of a fiber or fabric. Hand is a key consumer attribute and is required for holding and working certain monofilament dental devices.

As used herein, the term “tenacity” defines tensile strength expressed. as force per unit density of an unstrained sample.

As used herein, the term “denier” defines the weight in grams of a monofilament bundle or a monofilament tape that is 9000 meters long.

As used herein, the term “low-denier” is defined as between about 250 and about 550.

As used herein, the term “fibrillation” is defined as a splitting or tearing of drawn films into fibers and tapes into a mesh like structure with numerous penetrations of the film or tape

As used herein, the term “density” is defined as weight per unit volume.

As used herein, the term “elongation” is defined as the percent increase in length at break over starting length.

As used herein, the term “antifibrillation” is defined as the resistance to tearing in the transverse direction, 90 degrees from the machine direction.

### DETAILED DESCRIPTION OF THE PREFERRED EMBODIMENTS

The present invention comprises a coated, low-denier, monofilament dental tape, indicating extraordinary gentleness and ease of insertion, that is slit and drawn from biaxially oriented, HDPE, blown film into substantially fibrillation-free, low denier dental tape.

In a preferred embodiment of the invention, the HDPE resin modified with certain antifibrillation agents is blown extruded making a biaxially oriented, high density polyethylene (HDPE) film having a density of at least about 0.940, a melt index from between about 0.5 and about 10, wherein the HDPE is drawn longitudinally to a degree from between about 5:1 and about 15:1, thereby producing a biaxially oriented, blown HDPE film, preferably having a machine to transverse ratio of from about 1.6:1 to about 2.0:1.

This blown HDPE film having a thickness between about 3 and about 6 mils is then slit and drawn into dental tape having a thickness from between about 0.6 and about 3.0 and a width from between about 20 and about 80 mils. The film is slit and drawn at speeds ranging from between about 200 ft/minute and about 500 ft/minute. This tape substantially resists fibrillation during coating, bobbin winding and flossing.

Tables 1 and 2 compare properties of commercial coated monofilament tapes with the contact coated Bi-Ax™ HDPE tape of the present invention.

TABLE 1
Comparison of commercial coated monofilament tapes with contact coated Bi-Ax ™ HDPE tape

| Brand of | | | | | | Bi-Ax ™ HDPE |
|---|---|---|---|---|---|---|
| Monofilament Tape | Glide ® | Comfort Plus ® | easySLIDE ® | easySLIDE Pro ™ | Fibaclean ® | Dental Tape |
| Chemical composition | PTFE | PTFE | PTFE | Ultra high molecular | PEBAX ® | HDPE |
| of monofilament | | | | weight | | (See Example 1) |
| | | | | Polyethylene tape | | |
| Method of | Extruded | Extruded | Extruded | Compacted/ | Extruded | Extruded/blown, |
| manufacturing | | | | fibrillated | | subsequently slit |
| | | | | | | and drawn |
| Avg. Width in mils | 47 | 78 | 53 | 62 | 51 | 68 |
| Avg. Thickness in mils | 2.4 | 2.7 | 2.2 | 1.3 | 2.4 | 1.3 |
| Avg. Denier | 1200 | 1000 | 1500 | 420 | 740 | 480 |
| Percent elongation | 37 | 29 | 15 | 7 | 31 | 10 |
| Avg. Break Strength | 5 | 4.2 | 5.2 | 9.7 | 7.0 | 7.0 |
| Avg. Tenacity g/den | 1.9 | 1.5 | 1.6 | 10.4 | 4.3 | 6.6 |
| Type of Coating | Wax (6.1) | Wax (8) | Wax (1.3) | Compression (65) | Compression (55) | Contact coated (40) |
| Application (in mg/yd) | | | | | | |
| Saliva Solubility | Insoluble | Insoluble | Insoluble | Soluble | Soluble | Soluble |
| of coating | | | | | | |
| Hand | medium | good | medium | good | good | good |

TABLE 2
Dimensions of Commercial Monofilament Tapes compared to Bi-Ax ™ HDPE Tapes, along with Leading Edge Assessment

| | Coating | | Thickness in mils | | | | | Avg. | Width in mils | | | | | Avg. | Leading Edge |
|---|---|---|---|---|---|---|---|---|---|---|---|---|---|---|---|
| Product | mg/yd | Denier | 1 | 2 | 3 | 4 | 5 | Thickness | 1 | 2 | 3 | 4 | 5 | Width | Assessment |
| Comfort Plus ® | 8 | 1000 | 2.4 | 2.7 | 2.2 | 2.2 | 2.3 | 2.36 | 71 | 75 | 79 | 71 | 75 | 74 | Folded - Very gentle |
| Glide ® | 6.1 | 1200 | 2.2 | 2.2 | 2.3 | 2.3 | 2.3 | 2.26 | 47 | 46 | 48 | 47 | 47 | 47 | Folded - Gentle |
| easySLIDE ® | 1.3 | 1500 | 1.9 | 1.8 | 2.4 | 1.9 | 2.0 | 2.0 | 55 | 59 | 59 | 55 | 55 | 57 | Folded - fairly gentle |
| Fibaclean ® | 55 | 740 | 2.2 | 2.4 | 2.2 | 2.4 | 2.5 | 2.34 | 63 | 63 | 71 | 67 | 71 | 71 | Extruded edge - |
| | | | | | | | | | | | | | | | Fairly Gentle |
| Bi-Ax ™ HDPE | 47 | 452 | 1.2 | 1.1 | 1.1 | 1.2 | 1.2 | 1.16 | 75 | 75 | 71 | 71 | 75 | 74 | Rounded, |
| 452 denier | | | | | | | | | | | | | | | Very Gentle |
| (see Example 1) | | | | | | | | | | | | | | | |
| Bi-Ax ™ HDPE | 29 | 286 | 1.2 | 1.1 | 1.1 | 1.1 | 1.1 | 1.12 | 39 | 47 | 47 | 43 | 47 | 45 | Rounded Very Gentle |
| 286 denier | | | | | | | | | | | | | | | |
| (see Example 1) | | | | | | | | | | | | | | | |

The improved interproximal devices of the present invention contain a wide range of coatings including wax, contact and compression coatings that: (a) comprise from 10 to 120% by weight of the HDPE substrate, (b) are preferably saliva soluble, and (c) in a preferred embodiment are crystal free, and accordingly, exhibit a minimum of flaking. Preferably, these coatings are released in total into the oral cavity during flossing.

In a preferred embodiment, these various coatings contain ingredients such as: (a) SOFT ABRASIVES™ that work with the HDPE structure to help physically control, disrupt and remove biofilms (plaque) from interproximal and subgingival surfaces, (b) chemotherapeutic ingredients affecting oral health and subsequent systemic diseases caused or exacerbated by poor oral health, (c) cleaners that introduce detersive effects into the areas flossed, and (d) mouth conditioners. These coatings are particularly adapted for coating onto the HDPE tapes using wax coating, contact coating or compression coating means such as described herein to produce low-denier, gentle, easy-to-insert, interproximal devices of the present invention.

It has been discovered that the substantivity of certain emulsion coatings, compression and/or contact coating onto HDPE tapes of the present invention can be enhanced such that during flexure of the coated HDPE tape, these enhanced coatings remain substantive to said tape and resist cracking, fracturing and flaking off. Specifically, it has been observed that most compression and contact coated, flexible surfaces, especially those formulated to be saliva soluble and to carry effective quantities of abrasives, cleaners, surfactants, and chemotherapeutic agents; fracture along crystal faces during flexure of the tape and tend to prematurely release the ingredients from the flexible surface by cracking, chipping, flaking and/or falling off, etc. In response to these observations, it has been unexpectedly found that the addition of certain substances to various emulsion compression and contact coatings at relatively modest levels reduces crystal formation while simultaneously enhancing the coating's substantivity to these HDPE tapes when subjected to flexure. These properties thereby impart outstanding flake resistance and release values to said compression and contact coated HDPE interproximal devices of the invention.

Waxed coatings are applied to HDPE tapes of the invention utilizing standard waxing means presently used for multifilament and monofilament substrates. See U.S. Pat. Nos. 4,911,927; 5,165,913; 5,098,711; 5,711,935; 6,545,077; 2,667,443; 5,967,153; 5,908,039 and 5,830,495, which are incorporated herein by reference.

Those coating additives that reduce, control and/or eliminate crystal formation and enhance the substantivity of the loaded coating to flexible HDPE surfaces when added to these coatings at modest levels include certain aliphatic, long chain, fatty alcohols having from between about 10 and 30 carbon atoms and/or various liquid surfactants such as polyethylene glycol sorbitan dialiphatic esters.

Suitable aliphatic, long chain, fatty alcohols for the crystal-free coatings of the present invention can be represented by the structural formula ROH, wherein R represents a long chain alkyl group having from 20 to 30 carbon atoms. Specific examples include:

| | | |
|---|---|---|
| 1-decanol | 1-heptadecanol | 1-pentacosanol |
| 1 undecanol | 1-octadecanol | 1-hexacosanol |
| 1-dodecanol | 1-nonadecanol | 1-heptacosanol |
| 1-tetradecanol | 1-decosanol | 1-octacosanol |
| 1-pentadecanol | 1-henticosanol | 1-nonacosanol |
| 1-hexadecanol | 1-tricosanol | 1-triacosanol |
| 1-tetracosanol, | | |
| and mixtures thereof. | | |

Naturally occurring mixtures with substantial quantities of these fatty alcohols, or isomers thereof; including those chemically derived from natural sources also constitute suitable sources of aliphatic, long chain fatty alcohols for the purpose of this invention.

The long chain fatty alcohols can be purchased commercially from Stepan, Procter & Gamble and Aldrich Chemical Co. and a variety of companies processing vegetable and animal derived fatty alcohols.

Suitable liquid surfactants for the saliva-soluble, crystal-free coatings of the present invention include polyoxyethylene glycol sorbitan mono- and di-aliphatic esters represented by the general formula:

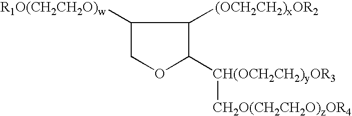

wherein R₁, R₂, R₃, R₄ and H or aliphatic acyl groups having from between about 10 and 30 carbon atoms, and the sum of w, x, y, and z is from between about 20 and about 80. These liquid surfactants are available under the trade name Emsorb®, Span®, Tween® from Cognis, N.A. and ICI. Specific examples of these include:

PEG 20 sorbitan monooleate (Tween® 80, ICI); PEG 40 sorbitan monostearate (SPAN 60 ICI) and PEG 40 sorbitan diisostearate (Eumulgin® SDI 40, Cognis N.A.).

Suitable solid surfactants that contribute to a solid-at-room-temperature coating matrix include:
sodium lauryl sulfate,
sodium lauryl sarcosinate,
polyethylene glycol stearate,
polyethylene glycol monostearate,
coconut monoglyceride sulfonates,
sodium alkyl sulfate,
sodium alkyl sulfoacetates,
block copolymers of polyoxyethylene and polyoxybutylene,
allylpolyglycol ether carboxylates,
polyethylene derivatives of sorbitan esters,
propoxylated cetyl alcohol,
block copolymers comprising a cogeneric mixtures of conjugated polyoxypropylene, and
polyoxyethylene compound having as a hydrophobe a polyoxypropylene polymer of at least 1200 molecular weight (these surfactants are generally described as poloxamers;
specific examples are described in the Examples below) as Poloxamer 407 and Poloxamer 388,
soap powder, and
mixtures thereof.

These same solid surfactants can, when desired, aid the proper emulsification of any of the waxes and other discontinuous, hydrophobic constituents in the formula.

Surprisingly, the wax, contact and compression coated HDPE interproximal devices of the present invention feature ultra shred-resistance combined with superior gentleness. The coatings released during flossing can deliver cleaners, mouth conditioners, chemotherapeutic ingredients, etc., along with SOFT ABRASIVES™ between teeth and below the gum line. These substances also collectively impart lubricity to the interproximal devices during flossing. This coated HDPE structure combines with the SOFT ABRASIVES™ released during flossing to gently control, disrupt and remove biofilm, tartar and stained pellicle from tooth surfaces between teeth and below the gum line.

The wax, contact and compression coated HDPE substrates, in combination with the SOFT ABRASIVES™ loaded on the coated HDPE interproximal device which is later released during flossing, creates a perceptible impression that the device is working to control, disrupt and remove biofilm, tartar, stained pellicle, debris, etc., as the device is being worked (usually with a sawing-action) between teeth. This “it's working” perception is a critical “compliance” advantage over most multifilament and monofilament dental devices available commercially.

The preferred saliva-soluble, substantially crystal-free emulsion coatings of the invention can contain various cleaners, SOFT ABRASIVES™, chemotherapeutic ingredients, as well as flavors, mouth conditioners, etc. These latter substances tend to leave a lasting (substantive) coating on surfaces in the oral cavity that imparts a refreshing, just-brushed feeling that also encourages and motivates regular flossing, particularly after meals and snacks while away-from-home. Particularly preferred mouth conditioners include various MICRODENT® and ULTRAMULSION® substances such as described in U.S. Pat. Nos. 4,911,927; 4,950,479; 5,032,387; 5,098,711; 5,165,913; 5,538,667; 5,645,841; 5,561,959 and 5,665,374.

The mechanical action of the coated HDPE substrate, in combination with SOFT ABRASIVES™ released in the various coatings during flossing, is further supplemented by the various cleaners including surfactants also released with these coatings during flossing. These released cleaners are readily soluble in the saliva and interproximal fluids and produce a detersive effect in the interproximal and subgingival regions. This detersive effect is critical in helping to loosen biofilm, tartar, stain residue and other debris from tooth surfaces.

In addition to the cleaners and SOFT ABRASIVES™ described above, the wax, contact and compression coatings added to the HDPE substrates can also contain various chemotherapeutic ingredients including anti-biofilm and anti-tartar agents, as well as active ingredients such as antimicrobials, biofilm attachment altering ingredients such as MICRODENT® and ULTRAMULSION®, and anti-tartar ingredients such as the pyrophosphates. All of these can be delivered interproximally and subgingivally by the coated HDPE interproximal devices of the present invention during flossing.

The innovative, biaxially oriented, HDPE interproximal devices of the present invention are designed to replace both:
a. commercial monofilament dental tapes such as P&G's Glide® and Comfort Plus®, J&J's easySLIDE®, Colgate's Total®, Oral-B's Satin® Floss, Jordan's Fibaclean®, as well as
b. commercial waxed, multifilament dental flosses such as J&J's REACH® Waxed Flosses, including the multiplicity of Private Label equivalents, and REACH® Gentle Gum Care and Ranir's Hi-Tech® Floss and J&J's easySLIDE Pro™.

The broad appeal of coated HDPE interproximal devices wax, contact and/or compression coated with various coatings to monofilament tape users and to multifilament floss users represents a major advance in commercial interproximal dental devices that promises to:
a. improve overall interproximal cleaning,
b. improve the disruption, control and/or removal of biofilm, tartar, stained pellicle, debris, etc., from tooth surfaces, and
c. encourage flossing compliance.

Accordingly, one embodiment of the present invention is directed to shred-resistant, oriented, low-denier, blown, slit and drawn HDPE interproximal devices, which are wax, contact or compression coated with liquid coatings including waxes, mixtures and/or emulsions containing: cleaners, chemotherapeutic ingredients and, in some instances, SOFT ABRASIVES™ at from between about 10 and about 120 mg/yd.

Advantageously, when the various coatings contain insoluble SOFT ABRASIVES™ of an appropriate particle size, these abrasives, once released, tend to compliment the HDPE structure during flossing to gently scrub biofilm, tartar and stained pellicle off tooth surfaces.

The various coated HDPE dental devices of the present invention are a most effective means for delivering chemotherapeutic substances to interproximal and subgingival areas of the oral cavity. The chemotherapeutic substances contained in the coatings loaded onto the dental devices of the present invention can be delivered to specific interproximal and subgingival sites during flossing. This site-specific delivery of localized concentrations of chemotherapeutics is obviously preferred over the use of systemic and/or mouth rinse treatments which impose substantially greater body burdens.

Various chemotherapeutic agents suitable for inclusion in the coatings of the present invention include:
1. anti-plaque and/or anti-tartar substances such as MICRODENT®, ULTRAMULSION®, tetrasodium pyrophosphate (TSPP), tetrapotassium pyrophosphate, sodium hexametaphosphate, etc.;
2. first generation anti-biofilm agents which are antibacterial agents with limited substantivity such as oxygenating compounds, quaternary ammonium compounds, phenolic compounds and plant alkaloids, including:
   a. quaternary ammonium compounds such as benzethonium chloride and cetylpyridinium chloride (CPC),
   b. phenolic compounds such as thymol and phenol, methyl salicylate and other compositions such as benzoic acid and boric acid,
   c. natural extracts (flavor oils) known to possess antimicrobial properties including eucalyptol,
   d. sanguinaria extract, alone or in combination with zinc chloride, or zinc chloride alone,
   e. triclosan, and
   f. iodine;
3. second generation agents which are antibacterial agents with substantivity such as chlorhexidine, either free base or as the gluconate or other suitable salt, alexidine, octenidine and stannous fluoride. The treatment of the oral cavity with stannous fluoride or chlorhexidine antimicrobial containing HDPE dental devices are preferred embodiments of the present invention;
4. desensitizing agents, antibiotics, anti-thrush agents, substances to neutralize candida sp. Yeasts, anti-caries agents, antimicrobials, COX-2 agents, etc.;
5. dry mouth relieving agents;
6. NSAIDs including aspirin;
7. antibiotics including doxycycline, tetracycline and minocycline; and
8. metronidazole.

Examples of saliva-insoluble formula modifiers suitable for the various coatings, include:
microcrystalline waxes,
paraffin wax,
carnauba, beeswax and other natural waxes,
animal and vegetable fats and oils, and
low-melt point, orally suitable polymers and copolymers.

Examples of saliva-soluble formula modifiers include so-called water soluble waxes, such as:
liquid polyethylene glycols,
solid polyethylene glycols,
liquid polyethylene glycols,
solid polypropylene glycols, and
triacetin.

Examples of low-melt temperature, water-soluble polymers, include:
hydroxyethylcellulose,
hydroxypropylcellulose,
carboxy derivatives of cellulose, and
orally suitable saliva getting or water-soluble copolymers of various resins.

Suitable emulsions of various coating substances in various surfactant continuous phases include those described and claimed in the various MICRODENT® and ULTRAMULSION® U.S. patents including U.S. Pat. Nos. 4,911,927; 4,950,479; 5,032,387; 5,098,711; 5,165,713; 5,538,667; 5,645,841; 5,561,959 and 5,665,374, all of which are hereby incorporated by reference.

Examples of suitable surfactants include:
sodium lauryl sulfate,
sodium lauryl sarcosinate,
polyethylene glycol stearate,
polyethylene glycol monostearate,
coconut monoglyceride sulfonates,
sodium alkyl sulfate,
sodium alkyl sulfoacetates,
block copolymers of polyoxyethylene and polyoxybutylene,
allylpolyglycol ether carboxylates,
polyethylene derivatives of sorbitan esters,
propoxylated cetyl alcohol,
block copolymers comprising a cogeneric mixtures of conjugated polyoxypropylene, and
polyoxyethylene compound having as a hydrophobe a polyoxypropylene polymer of at least 1200 molecular weight (these surfactants are generally described as poloxamers;
specific examples are described in the Examples below) as Poloxamer 407 and Poloxamer 388,
soap powder, and
mixtures thereof.

Examples of suitable coating substances include waxes (both natural and synthetic), silicones, silicone glycol copolymers and polydimethylsiloxanes at molecular weights from between about 700 cs and several million cs. (Specific examples are described in the Examples below including PDMS 2.5 million cs and ULTRAMULSION® 10-2.5.)

Suitable abrasives for use with HDPE devices of the present invention, which are designated by the trademark SOFT ABRASIVES™, include dicalcium phosphate (DCP), sodium hexametaphosphate, pumice, aluminum silicate, silica, glass beads, titanium oxide, rice flour, quartz, novaculite, silicon carbide, alumina zirconia, alumina, polishing alumina, calcined aluminum oxide, silicon and zirconium oxide; all of the foregoing at various crystal forms and particle shapes; various hardness including Rockwell 48-50c at various sieve analysis ranging from U.S. sieve #60 to #270; various specific gravity ranges including 2.65 g/cc, 3.20 g/cc, 4.3 g/cc, 3.6 to 3.9 g/cc.

These abrasives are preferably added to saliva-soluble coatings at between about 0.25% and about 20% by weight of the substrate. An alternative method for adding additional abrasive to coated devices is by means of a dusting process where the coated device is passed through a chamber charged with abrasive particles in the air, wherein the abrasive particles coat the coated device as it passes through the dusting chamber.

Suitable abrasives are commercially available from AGSCO Corp., Wheeling, Ill.

Suitable wax coating is described in U.S. Pat. Nos. 2,667,443; 5,967,153; 5,908,039 and 5,830,495.

Compression coating is described in U.S. Pat. Nos. 4,911,927; 5,098,711; 5,165,913; 5,651,959; 5,665,374; 5,711,935; 6,545,077; 6,575,176; 6,591,844; 6,604,534 and 6,609,527, which are hereby incorporated by reference.

The contact coating means used to coat the HDPE devices of the present invention comprises: a rotating wheel with a smooth surface to which a controlled level of heated liquid coating substance is continuously applied. Substantially, all of this liquid coating is transferred from the wheel surface to one side of a monofilament tape that is released from a package onto said coated wheel and eventually taken up by a driven winding means, generally in a direction counter to the rotation of said wheel, and at a controlled speed. Said tape tangentially contacts the coated wheel with minimum contact pressure at the coating transfer area of the wheel which comprises an arc of less than about 30° of said wheel. The contact between one side of said tape and the coating on the wheel is sufficient to lift substantially all of the heated liquid coating from the surface of said wheel onto the tape.

Shortly after the liquid coating has been transferred to one side of said tape, the coated tape is passed through a coating equalizing port where a portion of the liquid coating substance is continuously transferred from the coated side to the uncoated side of said tape, such that upon exiting the coating equalizing port, both sides of the tape are coated at about equal levels with said liquid coating.

The coated tape is then cooled and taken up onto a package using standard take-up winding means. The wound coated tape, having been cooled, is capable of being wound into a package by the take-up winder with minimum flaking and/or fracturing off of the saliva soluble coating. This take-up winding is carried out with minimum folding or bending of the coated tape on itself.

When unwound from the package, the contact coated HDPE tape remains substantially intact with minimal loss and/or damage to the coating occurring during bobbin winding and with no bending or fibrillating of the coated tape.

It will be obvious to one skilled in the art that contact coating methodology allows for coating formulations of a wide variety of viscosities, hydrophobic/hydrophilic properties, solid content and emulsion properties.

### EXAMPLES

Several commercial blown extrusion, biaxially oriented, HDPE films were slit and drawn into the dental tapes of the invention according to the process described in Example 1. These were tested as dental tapes. These are described in Charts 1 and 2 and Tables 4, 6 and 7, below.

### Examples 1 Through 42

These tapes described in Examples 1 through 42 are produced from blown, extruded HDPE films according to the process described in Example 1 below.

### Example 1

Resin granules comprised of 96% by weight Finathene 7194, a product of Atofina and 4% of EVAC (ethylene methyl acrylate), a product of Voridian, are fed into a hopper and then into the extruder. The extruder conveys the plastic pellets, heats and melts the plastic, and pressurizes the melt in order to force it through a die. The extruder consists of a screw, barrel, feed hopper, drive system, heating and cooling system, filtration and instrumentation to determine product quality. After extrusion the melt passes through a breaker plate with filter and then into the die which gives the shape, the surface finish and the structure. The melt extruded through a 16 inch diameter ring shaped opening in the die creates a tube. This tube is inflated with air to form a bubble. Once the molten bubble has exited the die lips, it needs cooling in order to fix the hot melt below its freezing point, to maintain the output level and to support the bubble. The tube is then guided and to be gradually flattened when it passes through the pinch rolls. The nip rollers are located at the top of the tower. When the lay film passes between them the top of the bubble is effectively sealed. The relative output speed of these rollers, blow up ratio and die gap determine the film thickness.

The blown film apparatus was adjusted to give a lay flat dimension of 40 inches corresponding to a blow up ratio of 1.6. Film samples at 4.25 mil and 4.5 mil thick, as reported in Table 7 and Examples 32-34 and 38-39, respectively, were run with this ratio. Other samples at 4.25 mil and 4.5 mil thick, Examples 35-37 and 41-42, respectively, were run with a 50 inch lay flat with a blow up ratio of 2.

The blown films were slit to give 6-inch wide films and taken up on winder machines to give 45 lb packages useful for the slitting operation. The 6-inch wide film packages were placed on unwinding creels and fed into a series of infeed godet rolls with nip rolls to minimize slippage. The film was fed at the rate of 28.5 ft per minute into a 10 foot long constant temperature oven manufactured by J.J. Jenkins. The temperature of the oven was set at 128 degrees Centigrade. Take-up godet rolls were set at 300 ft per minute. Slitting knives with 0.170-inch spacers were fitted to the infeed godet section to give ten monofilament tapes. After drawing, these tapes had a thickness of 1.47 mil and a width of 59 mils. Denier wheel measurement indicated 459 denier. Tensile testing gave 6.05 lbs breakstrength with 24.7 percent elongation. This tape, included as Example 32 in Table 7, was suitable for coating.

### Illustrative Examples 2 Through 11

Various Bi-Ax™ HDPE drawn and slit monofilament dental tapes such as described in Example 1 and in Charts 1 and 2 can be coated via: wax, contact or compression coating process with various formulations such as described in Table 3 below. Details on illustrative examples of coated Bi-Ax™ HDPE monofilament dental tapes of the invention are set out in Table 3 and described in Table 4 below.

TABLE 3
Illustrative Examples of Saliva-soluble coating formulations for biaxially oriented, HDPE dental tapes

| | | COATING | | | |
|---|---|---|---|---|---|
| | | | Primary Coating | Chemotherapeutic | Abrasive |
| Example | Types of | Coating Level | Ingredient | Ingredient | Ingredient |
| No. | Coating Process | (in mg/yd) | (in %) | (in %) | (in %) |
| 2 | Waxing | 20 | Saliva soluble wax & PEG (78) | Fluoride (0.039) | N/A |
| 3 | Waxing | 30 | Saliva soluble wax & PEG (70) | Fluoride (0.039) | N/A |
| 4 | Waxing | 40 | Saliva soluble wax & PEG (60) | Fluoride (0.039) | N/A |
| 5 | Compression Coating | 38 | MICRODENT ® (57) | TSPP (8) | SiO2 (6) |
| 6 | Compression Coating | 40 | ULTRAMULSION ® (68) | TSPP (12) | DCP (5) |
| 7 | Compression Coating | 42 | MICRODENT ® (55) | Triclosan (2.8) | SiO2 (6) |
| 8 | Compression Coating | 40 | ULTRAMULSION ® (60) | CPC (3.2) | DCP (8) |
| 9 | Contact Coating | 40 | ULTRAMULSION ® (60) | CHX (5.28) | SiO2 (7) |
| 10 | Contact Coating | 37 | MICRODENT ® (55) | CPC (3.2) | DCP (6) |
| 11 | Contact Coating | 35 | MICRODENT ® (55) | Listerine ® | SiO2 (6) |
| | | | | Essential Oils (12.8) | |

TABLE 4
Illustrative Examples of coated, extrusion blown, biaxially oriented, HDPE dental tapes

| | | | | | | Thickness of | |
|---|---|---|---|---|---|---|---|
| | Coating from | | Avg. | | | Blown film prior | |
| Example | Example No. | Avg. Width | Thickness | | Break Strength | to drawing | Draw |
| No. | (in mg/yd) | in mils | in mils | Denier | in pounds | in mils | Ratio |
| 12 | 22 (22) | 76 | 0.9 | 375 | 4.0 | 3.0 | 9:1 |
| 13 | 23 (20) | 65 | 1.1 | 400 | 4.8 | 3.65 | 10:1 |
| 14 | 24 (20) | 65 | 1.17 | 420 | 4.9 | 3.65 | 10:1 |
| 15 | 25 (70) | 72 | 1.2 | 480 | 7.0 | 4.25 | 10.5:1 |
| 16 | 26 (67) | 72 | 1.2 | 480 | 7.0 | 4.25 | 10.5:1 |
| 17 | 27 (82) | 72 | 1.2 | 480 | 6.9 | 4.25 | 10.5:1 |
| 18 | 28 (66) | 68 | 1.4 | 520 | 7.5 | 4.5 | 10.5:1 |
| 19 | 29 (34) | 68 | 1.4 | 520 | 7.5 | 4.5 | 10.5:1 |
| 20 | 30 (40) | 68 | 1.4 | 520 | 7.4 | 4.5 | 10.5:1 |
| 21 | 31 (45) | 68 | 1.4 | 520 | 7.5 | 4.5 | 10.5:1 |

TABLE 5
Composition of Illustrative Coating Examples 22-30

| | Antiplaque | Abrasive | Antitartar | Chemotherapeutic | Other |
|---|---|---|---|---|---|
| Example | Ingredient. | Ingredient | Ingredient | Ingredient | Ingredients(s) |
| No. | (% by wt.) | (% by wt.) | (% by wt.) | (% by wt.) | (% by wt.) |
| 22 | MICRODENT (55) | DCP (10) | SHMP (8) | NaF (0.039) | Flavor (8) |
| 23 | MICRODENT (55) | DCP (5) | SHMP (10) | CPC (3.2) | Flavor (10.2) |
| 24 | MICRODENT (55) | DCP (15) | TSPP (10) | CHX (5.36 | Flavor (7.6) |
| 25 | Ultramulsion (40) | SiO2 (4) | TSPP (6) | NA | Flavor (6) |
| 26 | Ultramulsion (40) | SiO2 (6) | TSPP (10) | NaF (0.039) | Flavor (8) |
| 27 | Ultramulsion (40) | SiO2 (8) | TSPP (12) | NaF (0.039) | Flavor (8) |
| 28 | MICRODENT (55) | Pumice (4) | TSPP (6) | NA | Flavor (6) |
| 29 | MICRODENT (55) | Pumice (6) | NA | NaF (0.039) | Flavor (7) |
| 30 | MICRODENT (55) | Pumice (8) | NA | NaF (0.039) | Flavor (8) |

### Example 31

A Bi-Ax™ HDPE tape, such as described in Example 1, was coated with: (a) wax and (b) hi-impact, saliva soluble coating, respectively. These coated HDPE tapes were compared to commercial: waxed mint J&J nylon floss, waxed Glide®, Hi-impact coated Fibaclean™ and J&J easySLIDE® Pro™. Subjective perception comparisons for each of the foregoing are reported in Table 6 below.

TABLE 6
Perception Comparison

| | | | Inverse | | | |
|---|---|---|---|---|---|---|
| | | | Emulsion | Hi Impact | Hi Impact | |
| | | | Coated | Saliva-Soluble | Saliva-Soluble | |
| Interproximal | J&J Waxed | Waxed | Bi-Ax ™ | Coated | Coated | easySLIDE ® |
| Device | Mint Nylon | Glide ® | HDPE | Bi-Ax ™ HDPE | Fibaclean ™ | Pro ™ |
| Remove & Cut | R = 1 | R = 1 | R = 1 | R = 1 | R = 2 | R = 1 |
| | C = 1 | C = 1 | C = 1 | C = 1 | C = 1 | C = 2 or 4 |
| Grip in hand | G = 2 | G = 4 | G = 2 | G = 2 | G = 2 | G = 1 |
| Insertion Ease | IE = 4 | IE = 1 | IE = 1 | IE = 1 | IE = 2 | IE = 2 |
| Snap or Stretch | SS = 2 | SS = 2 | SS = 1 | SS = 1 | SS = 4 | SS = 1 |
| Fraying in Use | F = 4 | F = 1 | F = 1 | F = 1 | F = 3 sl break | F = 2 |
| Taste | T = 4 | T = 4 | T = 3 | T = 1 | T = 1 | T = 1 |
| Mouthfeel | M = 5 | M = 5 | M = 4 | M = 1 | M = 1 | M = 1 |
| Taste after Use | TU = 5 | TU = 4 | TU = 3 | TU = 1 | TU = 1 | TU = 1 |
| Cleans | CL = 3 | CL = 5 | CL = 3 | CL = 2 | CL = 2 | CL = 1 |
| Gentleness | G = 4 | G = 1 | G = 1 | G = 1 | G = 1 | G = 1 |
| Pleasant to Use | P = 4 | P = 2 | P = 2 | P = 1 | P = 2 | P = 2 |

| FUNCTION | Scale |
|---|---|
| Remove & Cut | R = 1-5, one is very easy, five is very hard |
| | C = 1-5, one is very easy, five is very hard |
| Grip in hand | G = 1-5, one is very good, five is very poor |
| Insertion Ease | IE = 1-5, one is very easy, five is difficult |
| Snap or Stretch | SS = 1-5, one is no snap or stretch, 3 is perceivable, 5 is unpleasant |
| Fraying in Use | F = 1-5, 1 is little fraying, no breaking, 5 is much fraying with break |
| Taste | T = 1 is pleasant like toothpaste, 5 is no perceivable taste |
| Mouthfeel | M = 1 is very pleasant, smooth, clean, 5 is no perception |
| Taste after Use | TU = 1 is pleasant aftertaste, 3 is no aftertaste, 5 is bad aftertaste |
| Cleans | CL = 1 is between teeth feels very clean, 5 is not clean at all |
| Gentleness | G = 1 is very gentle, no pain, 5 is painful, cutting |
| Pleasant to Use | P = 1 is overall very pleasant experience, 5 is overall bad experience |

### Examples 32 to 42

Rolls of films prepared as described in Example 1 comprised of about 96% by wt. HDPE and about 4% by wt. EVAC were slit and drawn in to dental tape at speeds ranging from between about 300 ft/min and about 450 ft/min. The tape dimensions after slitting and drawing are described in Table 7 below. Some of these tapes were subsequently coated and tested as interproximal dental devices. (See Table 6 above.)

TABLE 7
Tape Dimensions after Slitting and
Drawing Various HDPE Base Films

| | | Tape Dimensions after Slitting and Drawing⁽¹⁾⁽²⁾ | | | | |
|---|---|---|---|---|---|---|
| Exam- | Base Film | | | Break- | | |
| ple | Thickness | Thickness | Width | strength | | Elong. |
| No. | (in mils) | (in mils) | (in mils) | (in lbs) | Denier | (in %) |
| 32 | 4.25 | 1.47 | 59 | 6.05 | 459 | 24.7 |
| 33 | 4.25 | 1.50 | 63 | 6.65 | 503 | 26.2 |
| 34 | 4.25 | 1.47 | 76 | 6.57 | 626 | 22.6 |
| 35 | 4.25 | 1.37 | 52 | 5.21 | 411 | 31.0 |
| 36 | 4.25 | 1.35 | 63 | 5.30 | 466 | 27.3 |
| 37 | 4.25 | 1.47 | 69 | 7.77 | 567 | 25.9 |
| 38 | 4.5 | 1.67 | 52 | 6.41 | 500 | 28.2 |
| 39 | 4.5 | 1.64 | 86 | 6.95 | 594 | 21.8 |
| 40 | 4.5 | 1.67 | 76 | 7.16 | 657 | 24.6 |
| 41 | 4.5 | 1.62 | 51 | 6.38 | 429 | 23.8 |
| 42 | 4.5 | 1.61 | 59 | 6.42 | 535 | 25.7 |

⁽¹⁾Drawing speeds ranged from between about 300 ft/min and about 450 ft/min.
⁽²⁾Drawing temperature ranged from between about 120° C. and about 130° C.

The present invention has been described in detail, including the preferred embodiments thereof. However, it will be appreciated that those skilled in the art, upon consideration of the present disclosure, may make modifications and/or improvements on this invention and still be within the scope of this invention as set forth in the following claims.

What is claimed is:

1. A coated, low-denier, monofilament, shred-resistant dental tape, which is slit and drawn from extrusion blown HDPE film indicating transverse and longitudinal orientation, high break strength and a rounded edge.

2. A dental tape according to claim 1, wherein said tape is coated with a coating selected from the group consisting of wax; compression-saliva soluble-substantially-crystal-free coatings; and contact-saliva soluble-substantially-crystal-free coatings; wherein said coating is applied at from between about 10 and about 80 mg/yd.

3. A dental tape according to claim 1, wherein said tape is from between about 0.6 and about 2 mils thick and from between about 20 and about 80 mils wide.

4. A dental tape according to claim 1, wherein said HDPE film has a density of at least about 0.940 g/cc.

5. A dental tape according to claim 1, wherein said tape has a denier between about 350 and about 550.

6. A dental tape according to claim 1, wherein said HDPE film is drawn at between about 3:1 and 16:1.

7. A dental tape according to claim 1, wherein said tape has a break strength of at least about four pounds.

8. A dental tape according to claim 1, wherein said HDPE film contains a minor amount of an anti-fibrillation resin.

9. A method for controlling, disrupting and removing biofilms from interproximal tooth surfaces comprising routinely flossing with a coated, low-denier, monofilament, shred-resistant dental tape, slit and drawn from extrusion blown HDPE film, indicating transverse and longitudinal orientation, high break strength and a rounded edge.

10. A method according to claim 9, wherein said tape is coated with a coating selected from the group consisting of wax; compression—saliva-soluble-substantially crystal-free coatings; and contact—saliva-soluble-substantially crystal-free coatings; wherein said coating is applied at from between about 10 and about 80 mg/yd.

11. A method for controlling, disrupting and removing biofilms from interproximal tooth surfaces according to claim 9, wherein said tape is from between about 0.6 and about 2 mils thick and from between about 20 and about 80 mils wide.

12. A method for controlling, disrupting and removing biofilms from interproximal tooth surfaces according to claim 9, wherein said HDPE film has a density of at least about 0.940 g/cc.

13. A method for controlling, disrupting and removing biofilms from interproximal tooth surfaces according to claim 9, wherein said tape has a denier from between about 350 and about 550.

14. A method for controlling, disrupting and removing biofilms from interproximal tooth surfaces according to claim 8, wherein said film is drawn at between about 3:1 and 16:1.

15. A method for controlling, disrupting and removing biofilms from interproximal tooth surfaces according to claim 9, wherein said tape has a break strength of at least about four pounds.

16. A method for controlling, disrupting and removing biofilms from interproximal tooth surfaces according to claim 9, wherein said HDPE film contains a minor amount of an anti-fibrillation resin.

17. A method for manufacturing coated, low-denier, monofilament, shred-resistant dental tape, slit and drawn from extrusion blow molded HDPE film, indicating transverse and longitudinal orientation, high break strength and a rounded edge, comprising:
a. slitting and drawing said film into a shred resistant tape that is substantially fibrillation free with rounded edges, and
b. coating said tape with a coating selected from the group consisting of wax; compression- saliva-soluble-substantially crystal-free coatings; and contact- saliva-soluble-substantially crystal-free coatings; wherein said coating is applied at from between about 10 and about 80 mg/yd.

18. A method for manufacturing coated, low-denier, monofilament dental tape, according to claim 17, wherein said tape is from between about 0.6 and about 2 mils thick and from between about 20 and about 80 mils wide.

19. A method for manufacturing coated, low-denier, monofilament dental tape, according to claim 17, wherein said HDPE film has a density of at least about 0.940 g/cc.

20. A method for manufacturing coated, low-denier, monofilament dental tape, according to claim 17, wherein said tape has a denier from between about 350 and about 550.

21. A method for manufacturing coated, low-denier, monofilament dental tape, according to claim 17, wherein said film is drawn at between about 3:1 and 16:1.

22. A method for manufacturing coated, low-denier, monofilament dental tape, according to claim 17, wherein said tape has a break strength of at least about four pounds.

23. A method for manufacturing coated, low-denier, monofilament dental tape, according to claim 17, wherein said HDPE film contains a minor amount of an anti-fibrillation resin.
